(19) United States
(12) Patent Application Publication
(10) Pub. No.: US 2026/0253034 A1
(43) Pub. Date: Aug. 27, 2026

(54) SYSTEM

(71) Applicant: SoftBank Group Corp., Tokyo (JP)

(72) Inventor: Hibiki SHIMBO, Tokyo (JP)

(73) Assignee: SoftBank Group Corp., Tokyo (JP)

(21) Appl. No.: 19/541,418

(22) Filed: Feb. 17, 2026

(30) Foreign Application Priority Data
Feb. 21, 2025 (JP) 2025-026975

(51) Int. Cl. G06Q 10/10; G06F 9/48

(52) U.S. Cl. CPC G06Q 10/10; G06F 9/4881

(57) ABSTRACT

The system according to the embodiment comprises a collection unit, an analysis unit, a generation unit, and a provision unit. The collection unit collects data on household tasks. The analysis unit analyzes the data collected by the collection unit and learns the time required for household tasks. The generation unit generates procedures for time reduction based on the results learned by the analysis unit. The provision unit provides the procedures generated by the generation unit to a user.

### CROSS-REFERENCE TO RELATED APPLICATION

The present application claims priority to and incorporates by reference the entire contents of Japanese Patent Application No. 2025-026975 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to effectively provide procedures for improving the efficiency of household tasks and reducing the time required for such tasks.

### SUMMARY OF THE INVENTION

The system according to the embodiment comprises a collection unit, an analysis unit, a generation unit, and a provision unit. The collection unit collects data on household tasks. The analysis unit analyzes the data collected by the collection unit and learns the time required for household tasks. The generation unit generates procedures for time reduction based on the results learned by the analysis unit. The provision unit provides the procedures generated by the generation unit to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

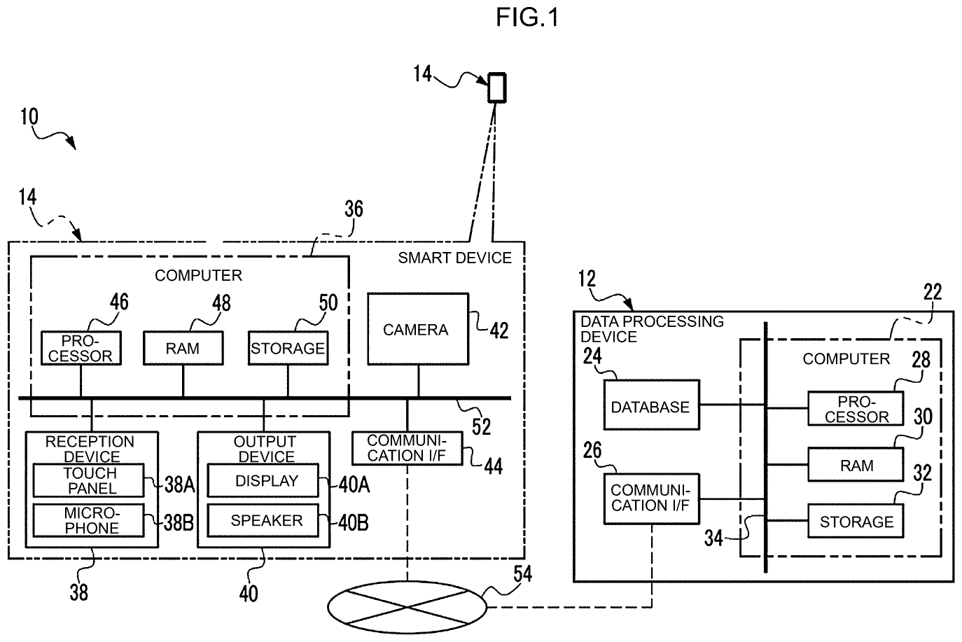

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

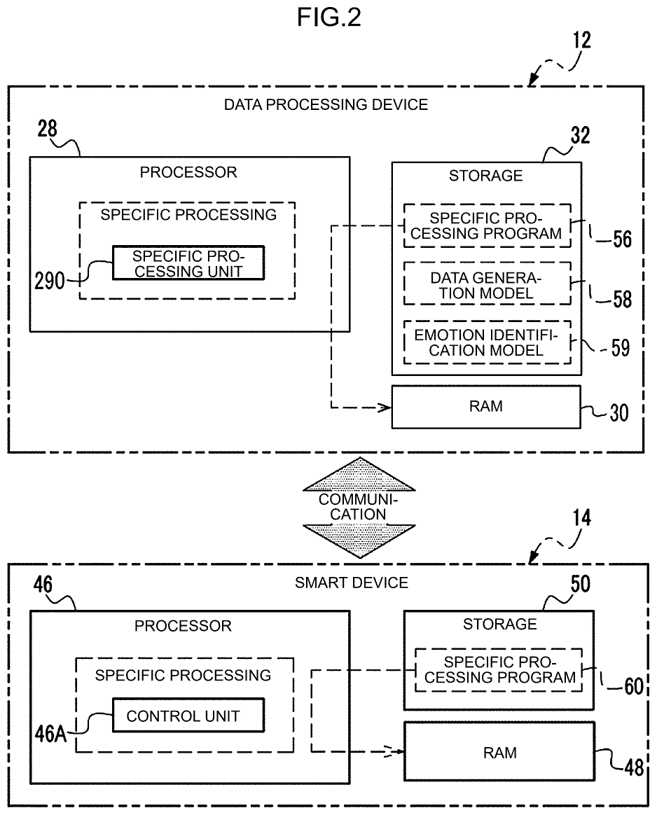

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The household task efficiency system according to the embodiment of the present invention is a system that learns the time required for household tasks in each household through a wearable device, outputs procedures for time reduction, and communicates them to the user. This household task efficiency system collects data on household tasks in each household, and AI analyzes the data to learn the time required for household tasks. Furthermore, based on the results learned by the AI, optimal procedures for time reduction are generated and output to the user. For example, the household task efficiency system collects data on household tasks in each household. At this time, detailed data such as the type, time, and procedures of household tasks are collected. For example, the time and procedures required for household tasks such as cleaning, laundry, and cooking are recorded. This enables the actual conditions of household tasks in each household to be grasped. Next, the collected data is analyzed by AI. The AI learns the time required for household tasks based on the collected data. For example, the time and procedures required for cleaning are analyzed to identify which parts require more time. This allows points for efficiency improvement in household tasks to be identified. Furthermore, based on the results learned by the AI, optimal procedures for time reduction are generated. The AI proposes procedures for improving the efficiency of household tasks and outputs them to the user. For example, the cleaning procedures are reviewed, and efficient cleaning methods are proposed. As a result, the user can reduce the time required for household tasks. Through this mechanism, the user can always receive methods for time reduction. For example, by practicing the efficient cleaning methods proposed by the AI, the time required for cleaning can be reduced. In addition, by inputting methods from household workers nationwide, traditional methods continued in local areas can also be reproduced. For example, the AI learns cleaning methods that are traditionally practiced in local areas and proposes these methods to the user, thereby enabling the reproduction of traditional methods. As a result, the household task efficiency system can improve the efficiency of household tasks. Specifically, the household task efficiency system samples various time-series data such as acceleration sensor data, voice recordings, image data, and touch operation logs obtained from wearable devices, for example, every second, and collects each data as time-series tensors (e.g., for acceleration sensors, 3 axes×number of samples; for voice, spectrogram images; for images, RGB value arrays). The system performs noise removal, normalization, and feature extraction (e.g., detection of operation start/end, segmentation of work intervals, tool identification) in a preprocessing unit, and generates a structured database for each household task, including “task type,” “start time,” “end time,” “tools used,” and “procedure number.” The system uses the collected data as input and, for example, applies convolutional neural networks (CNNs), recurrent neural networks (RNNs) for time-series analysis, or Transformer-based models to automatically extract the time required for each step of household tasks, dependencies between tasks, and bottleneck sections affecting work efficiency. Examples of input to the AI model include “time-series acceleration sensor data for cleaning tasks (3 axes×600 samples),” “spectrogram images of voice recordings (128×256 pixels),” and “procedure text (e.g., ‘vacuuming→wiping with a cloth→taking out the trash’).” The AI model generates outputs such as “required time for each step (e.g., vacuuming 10 minutes, wiping with a cloth 5 minutes, taking out the trash 2 minutes),” “procedures that can be optimized (e.g., recommendation to swap the order of vacuuming and wiping with a cloth),” and “work efficiency score (e.g., 0.85).” Examples of output include “Procedure A: vacuuming→wiping with a cloth→taking out the trash (required time 17 minutes, efficiency score 0.85)” and “Procedure B: wiping with a cloth→vacuuming→taking out the trash (required time 15 minutes, efficiency score 0.92).” The system evaluates these outputs in a threshold determination unit and recommends procedures with high efficiency scores to the user. Furthermore, the system analyzes traditional method data collected from household workers nationwide (e.g., region-specific cleaning procedure texts, videos, voice explanations) using natural language processing models and multimodal AI, and generates procedures that take into account regional characteristics and cultural backgrounds. As a result, the system achieves not only automation of human tasks but also improvement of computer technology itself (e.g., improved analysis accuracy, increased proposal speed, enhanced database scalability) by analyzing vast time-series and multidimensional data in high-dimensional space and automatically extracting efficiency patterns and procedure optimization rules that could not be discovered by humans. Application fields include household support in general homes, work efficiency improvement in nursing care settings, optimization of cleaning and cooking procedures in hotels and restaurants, and support for the inheritance of traditional culture in local governments.

The household task efficiency system according to the embodiment comprises a collection unit, an analysis unit, a generation unit, and a provision unit. The collection unit collects data on household tasks. The data on household tasks may include, for example, work data for cleaning, laundry, and cooking, but is not limited to such examples. The collection unit collects data on household tasks using, for example, a wearable device. The wearable device can collect detailed data such as the type, time, and procedures of household tasks. For example, the collection unit records the tools and procedures used during cleaning and collects them as data. The collection unit can also record and collect the procedures and time for laundry as data. Furthermore, the collection unit can record and collect the procedures and time for cooking as data. The analysis unit analyzes the data collected by the collection unit and learns the time required for household tasks. The analysis unit, for example, identifies points for efficiency improvement in household tasks based on the collected data. For example, the analysis unit analyzes the time and procedures required for cleaning to identify which parts require more time. The analysis unit can also analyze the time and procedures required for laundry to identify points for efficiency improvement. Furthermore, the analysis unit can analyze the time and procedures required for cooking to identify points for efficiency improvement. The generation unit generates procedures for time reduction based on the results learned by the analysis unit. The generation unit, for example, proposes procedures for improving the efficiency of household tasks. For example, the generation unit reviews cleaning procedures and proposes efficient cleaning methods. The generation unit can also review laundry procedures and propose efficient laundry methods. Furthermore, the generation unit can review cooking procedures and propose efficient cooking methods. The provision unit provides the procedures generated by the generation unit to the user. The provision unit, for example, notifies the procedures through an application. For example, the provision unit notifies efficient cleaning methods through a smartphone application. The provision unit can also provide procedures through printed guides. For example, the provision unit prints and provides guides describing efficient laundry methods. Furthermore, the provision unit can provide procedures via email. For example, the provision unit sends emails describing efficient cooking methods. As a result, the household task efficiency system according to the embodiment can improve the efficiency of household tasks. Some or all of the above-described processing in the provision unit may be performed using AI or without using AI. For example, the provision unit can use an AI model that outputs procedures based on the procedures generated by the generation unit as input to provide the procedures. Specifically, the household task efficiency system samples various time-series data such as acceleration sensor data (e.g., 3 axes×number of samples), voice recordings (e.g., WAV files sampled at 16 kHz), image data (e.g., 640×480 pixel RGB images), and touch operation logs (e.g., event sequences with timestamps) from wearable devices every second in the collection unit and collects them as time-series tensors. The system sends the data obtained in the collection unit to a preprocessing unit, where noise removal (e.g., high-frequency component removal using a Butterworth filter), normalization (e.g., Z-score normalization for each axis), and feature extraction (e.g., detection of operation start/end, segmentation of work intervals, tool identification) are performed to generate a structured database for each household task, including “task type,” “start time,” “end time,” “tools used,” and “procedure number.” The analysis unit uses these structured data as input and applies convolutional neural networks (CNNs), recurrent neural networks (RNNs) for time-series analysis, or Transformer-based models to automatically extract the time required for each step of household tasks, dependencies between tasks, and bottleneck sections affecting work efficiency. Examples of input to the AI model include “time-series acceleration sensor data for cleaning tasks (3 axes×600 samples),” “spectrogram images of voice recordings (128×256 pixels),” and “procedure text (e.g., ‘vacuuming→wiping with a cloth→taking out the trash’).” The AI model generates outputs such as “required time for each step (e.g., vacuuming 10 minutes, wiping with a cloth 5 minutes, taking out the trash 2 minutes),” “procedures that can be optimized (e.g., recommendation to swap the order of vacuuming and wiping with a cloth),” and “work efficiency score (e.g., 0.85).” Examples of output include “Procedure A: vacuuming→wiping with a cloth→taking out the trash (required time 17 minutes, efficiency score 0.85)” and “Procedure B: wiping with a cloth→vacuuming→taking out the trash (required time 15 minutes, efficiency score 0.92).” The generation unit applies procedure optimization algorithms (e.g., dynamic programming, reinforcement learning-based procedure generation) based on efficiency improvement points and bottleneck information obtained from the analysis unit to generate household task procedures optimized for each user. The generation unit can also generate procedures that take into account traditional methods and regional characteristics by utilizing natural language processing models and multimodal AI to analyze region-specific cleaning procedure texts, videos, and voice explanations, and generate procedures reflecting cultural backgrounds. The provision unit provides the procedures output from the generation unit to the user through various channels such as smartphone apps, printed guides, emails, and voice assistants. The provision unit can automatically select the optimal provision method and notification timing using AI according to the user's usage history, emotional state, and living situation. The output of the AI model is evaluated in a threshold determination unit, and only procedures with high efficiency scores are recommended to the user. This series of processing differs from conventional manual work and simple rule-based processing, and by analyzing vast multidimensional time-series data in high-dimensional space, automatically extracts efficiency patterns and procedure optimization rules that could not be discovered before, resulting in improvement effects in computer technology itself (e.g., improved analysis accuracy, increased proposal speed, enhanced database scalability). Application fields include household support in general homes, work efficiency improvement in nursing care settings, optimization of cleaning and cooking procedures in hotels and restaurants, and support for the inheritance of traditional culture in local governments.

The collection unit can collect data on the type or time, and procedures of household tasks. For example, the collection unit collects the type of household tasks. For example, the collection unit records the types of household tasks such as cleaning, laundry, and cooking. The collection unit can also collect the time required for household tasks. For example, the collection unit records the time required for cleaning and collects it as data. The collection unit can also record and collect the time required for laundry as data. Furthermore, the collection unit can record and collect the time required for cooking as data. The collection unit can also collect procedures for household tasks. For example, the collection unit records the procedures for cleaning and collects them as data. The collection unit can also record and collect the procedures for laundry as data. Furthermore, the collection unit can record and collect the procedures for cooking as data. By collecting detailed data on household tasks, more accurate analysis becomes possible. Some or all of the above-described processing in the collection unit may be performed using AI or without using AI. For example, the collection unit can input data on household tasks to AI and have the AI perform the data collection. Specifically, the collection unit samples various time-series data such as acceleration sensor data (e.g., time-series tensors of 3 axes×number of samples), voice recordings (e.g., WAV files sampled at 16 kHz), image data (e.g., 640×480 pixel RGB images), and touch operation logs (e.g., event sequences with timestamps) from multiple hardware devices such as wearable devices, smartphones, and stationary sensor units every second. The collection unit sends these data to a preprocessing unit, where noise removal (e.g., high-frequency component removal using a Butterworth filter), normalization (e.g., Z-score normalization for each axis), and feature extraction (e.g., detection of operation start/end, segmentation of work intervals, tool identification) are performed to generate a structured database for each household task, including “task type,” “start time,” “end time,” “tools used,” and “procedure number.” The collection unit generates, as input to the AI model, for example, “time-series acceleration sensor data for cleaning tasks (3 axes×600 samples),” “spectrogram images of voice recordings (128×256 pixels),” and “procedure text (e.g., ‘vacuuming→wiping with a cloth→taking out the trash’).” The AI model generates outputs such as “required time for each step (e.g., vacuuming 10 minutes, wiping with a cloth 5 minutes, taking out the trash 2 minutes),” “procedures that can be optimized (e.g., recommendation to swap the order of vacuuming and wiping with a cloth),” and “work efficiency score (e.g., 0.85).” Examples of output include “Procedure A: vacuuming→wiping with a cloth→taking out the trash (required time 17 minutes, efficiency score 0.85)” and “Procedure B: wiping with a cloth→vacuuming→taking out the trash (required time 15 minutes, efficiency score 0.92).” The collection unit uses these outputs as basic data for evaluation in a threshold determination unit to recommend procedures with high efficiency scores to the user. Internally, the AI model uses convolutional neural networks (CNNs), recurrent neural networks (RNNs), Transformer-based models, etc., to multilayered analysis of time-series data, image data, and text data, and automatically extracts efficiency patterns and procedure optimization rules that could not be discovered by conventional human work. As a result, the invention achieves not only automation of human tasks but also improvement effects in computer technology itself, such as improved analysis accuracy, increased proposal speed, and enhanced database scalability, by analyzing vast time-series and multidimensional data in high-dimensional space. Application fields include household support in general homes, work efficiency improvement in nursing care settings, optimization of cleaning and cooking procedures in hotels and restaurants, and support for the inheritance of traditional culture in local governments.

The analysis unit can learn the time required for household tasks based on the collected data. For example, the analysis unit identifies points for efficiency improvement in household tasks based on the collected data. For example, the analysis unit analyzes the time and procedures required for cleaning to identify which parts require more time. The analysis unit can also analyze the time and procedures required for laundry to identify points for efficiency improvement. Furthermore, the analysis unit can analyze the time and procedures required for cooking to identify points for efficiency improvement. By learning the time required for household tasks, points for efficiency improvement can be identified. Some or all of the above-described processing in the analysis unit may be performed using AI or without using AI. For example, the analysis unit can input the collected data to AI and have the AI perform the data analysis. Specifically, the analysis unit inputs various data such as acceleration sensor data (time-series tensors of 3 axes×number of samples) received from the collection unit, voice recordings (spectrogram images), image data (RGB value arrays), touch operation logs (event sequences), and procedure texts to AI architectures such as convolutional neural networks (CNNs), recurrent neural networks (RNNs), and Transformer-based models. Examples of input to the AI model include “time-series acceleration sensor data for cleaning tasks (3 axes×600 samples),” “spectrogram images of voice recordings (128×256 pixels),” and “procedure text (e.g., ‘vacuuming→wiping with a cloth→taking out the trash’).” The analysis unit performs noise removal, normalization, and feature extraction (e.g., segmentation of operation intervals, tool identification) in a preprocessing unit before inputting the data to the AI model. The AI model generates outputs such as “required time for each step (e.g., vacuuming 10 minutes, wiping with a cloth 5 minutes, taking out the trash 2 minutes),” “procedures that can be optimized (e.g., recommendation to swap the order of vacuuming and wiping with a cloth),” and “work efficiency score (e.g., 0.85).” Examples of output include “Procedure A: vacuuming→wiping with a cloth→taking out the trash (required time 17 minutes, efficiency score 0.85)” and “Procedure B: wiping with a cloth→vacuuming→taking out the trash (required time 15 minutes, efficiency score 0.92).” The analysis unit evaluates these outputs in a threshold determination unit to identify procedures with high efficiency scores and bottleneck steps. Internally, the AI model combines, for example, CNNs for image and time-series feature extraction, RNNs for learning dependencies between steps, and Transformers for analyzing long-term dependencies, to realize pattern extraction in high-dimensional space, which differs from conventional human work and simple rule-based processing. The AI model uses supervised learning (e.g., minimizing loss functions with actual work time-labeled data) and reinforcement learning (e.g., procedure generation aimed at maximizing efficiency scores) to improve accuracy. As a result, the analysis unit analyzes vast multidimensional time-series data and automatically extracts efficiency improvement points and procedure optimization rules that could not be discovered before, thereby achieving improvement effects in computer technology itself, such as improved analysis accuracy, increased proposal speed, and enhanced database scalability. Application fields include household support in general homes, work efficiency improvement in nursing care settings, optimization of cleaning and cooking procedures in hotels and restaurants, and support for the inheritance of traditional culture in local governments.

The generation unit can generate procedures for time reduction based on the learned results. The generation unit, for example, proposes procedures for improving the efficiency of household tasks. For example, the generation unit reviews cleaning procedures and proposes efficient cleaning methods. The generation unit can also review laundry procedures and propose efficient laundry methods. Furthermore, the generation unit can review cooking procedures and propose efficient cooking methods. By generating optimal procedures for time reduction, the efficiency of household tasks can be improved. Some or all of the above-described processing in the generation unit may be performed using AI or without using AI. For example, the generation unit can input the learned results to AI and have the AI perform the procedure generation. Specifically, the generation unit applies procedure optimization algorithms (e.g., dynamic programming, reinforcement learning-based procedure generation, genetic algorithms) to output data such as “required time for each step,” “procedures that can be optimized,” and “work efficiency score” obtained from the analysis unit, and generates household task procedures optimized for each user. For example, in cleaning tasks, the generation unit can propose a procedure that changes the order from “vacuuming→wiping with a cloth→taking out the trash” to “wiping with a cloth→vacuuming→taking out the trash,” thereby reducing the required time from 17 minutes to 15 minutes and improving the efficiency score from 0.85 to 0.92. Examples of input to the AI model include “list of work steps (e.g., vacuuming, wiping with a cloth, taking out the trash),” “required time for each step (e.g., 10 minutes, 5 minutes, 2 minutes),” and “dependency matrix between steps.” The AI model generates outputs such as “optimal procedure order,” “estimated required time,” and “efficiency score.” Examples of output include “Procedure A: vacuuming→wiping with a cloth→taking out the trash (required time 17 minutes, efficiency score 0.85)” and “Procedure B: wiping with a cloth→vacuuming→taking out the trash (required time 15 minutes, efficiency score 0.92).” The generation unit can also generate procedures that take into account traditional methods and regional characteristics by utilizing natural language processing models and multimodal AI to analyze region-specific cleaning procedure texts, videos, and voice explanations, and generate procedures reflecting cultural backgrounds. Internally, the AI model uses a reinforcement learning agent to repeatedly perform actions such as “reordering procedures,” “omitting or adding steps,” and “selecting tools,” and searches for optimal procedures based on a reward function (e.g., time reduction, maximizing efficiency score). As a result, the generation unit achieves not only automation of human tasks but also improvement effects in computer technology itself, such as improved analysis accuracy, increased proposal speed, and enhanced database scalability, by analyzing vast multidimensional time-series data in high-dimensional space and automatically extracting efficiency patterns and procedure optimization rules that could not be discovered before. Application fields include household support in general homes, work efficiency improvement in nursing care settings, optimization of cleaning and cooking procedures in hotels and restaurants, and support for the inheritance of traditional culture in local governments.

The provision unit can provide the generated procedures to the user. The provision unit, for example, notifies the procedures through an application. For example, the provision unit notifies efficient cleaning methods through a smartphone application. The provision unit can also provide procedures through printed guides. For example, the provision unit prints and provides guides describing efficient laundry methods. Furthermore, the provision unit can provide procedures via email. For example, the provision unit sends emails describing efficient cooking methods. By providing the generated procedures to the user, the user can perform household tasks efficiently. Some or all of the above-described processing in the provision unit may be performed using AI or without using AI. For example, the provision unit can use an AI model that outputs procedures based on the procedures generated by the generation unit as input to provide the procedures. Specifically, the provision unit receives optimized procedure data output from the generation unit (e.g., “Procedure A: vacuuming→wiping with a cloth→taking out the trash (required time 17 minutes, efficiency score 0.85)”) and, considering metadata such as the user's usage environment and device type (smartphone, tablet, PC, smart speaker, etc.), usage history, emotional state, and living situation, automatically selects the optimal provision method and notification timing. Examples of input to the AI model include “procedure data (text format),” “user device information (e.g., iOS/Android/PC),” “user usage history (e.g., number of procedure views in the past 30 days),” and “user emotion estimation value (e.g., stress level 0.7).” The AI model generates outputs such as “notification method (e.g., app notification, email, printed guide, voice assistant),” “notification timing (e.g., 8 a.m., immediately before the task),” and “level of detail of notification content (e.g., summary/detailed version).” Examples of output include “notify detailed procedures via smartphone app at 8 a.m. ,” “mail printed guide on weekends,” and “read summary procedures via voice assistant immediately before the task.” The provision unit provides procedures to the user in the optimal form based on the output of the AI model, supporting efficient household tasks while reducing the user's burden. Internally, the AI model learns from past user response data and usage history using supervised learning to optimize notification method, timing, and content. As a result, the provision unit achieves personalized notifications for each user, which differ from conventional uniform information provision, and brings improvement effects in computer technology itself, such as increased proposal speed, improved user satisfaction, and enhanced system scalability. Application fields include household support in general homes, work efficiency improvement in nursing care settings, optimization of cleaning and cooking procedures in hotels and restaurants, and support for the inheritance of traditional culture in local governments.

The provision unit can input methods from household workers nationwide and provide procedures that reproduce traditional methods continued in local areas. The provision unit, for example, inputs methods from household workers nationwide. For example, the provision unit collects methods from household workers through surveys and interviews. The provision unit can also provide procedures that reproduce traditional methods continued in local areas. For example, the provision unit collects unique household task methods practiced in specific regions and provides procedures that reproduce those methods. By reproducing traditional methods continued in local areas, efficient household tasks can be performed while respecting regional culture. Some or all of the above-described processing in the provision unit may be performed using AI or without using AI. For example, the provision unit can input methods from household workers to AI and have the AI perform the procedure generation. Specifically, the provision unit inputs traditional method data collected from household workers nationwide (e.g., region-specific cleaning procedure texts, videos, voice explanations, instruction manuals with photos) to natural language processing models or multimodal AI models. Examples of input to the AI model include “traditional cleaning procedure text (e.g., ‘air out tatami mats→sweep with a broom→wipe with water’),” “video data (e.g., footage of cleaning during regional events),” and “voice explanations (e.g., procedure explanations in dialect).” The AI model generates outputs such as “standardized procedure text (e.g., ‘air out tatami mats→sweep with a broom→wipe with water’),” “regional label (e.g., Tohoku region, Kansai region),” and “cultural background explanation (e.g., relation to annual events).” Examples of output include “Traditional cleaning procedure in the Tohoku region: air out tatami mats→sweep with a broom→wipe with water (cultural background: year-end cleaning event).” The provision unit provides these outputs to users in the optimal form according to their residential region and areas of interest. Internally, a Transformer-based natural language processing model analyzes text data, and multimodal AI extracts and integrates features from image, video, and voice data, realizing pattern extraction in high-dimensional space, which differs from conventional human work and simple rule-based processing. As a result, the provision unit brings improvement effects in computer technology itself, such as digital archiving of traditional methods, support for the inheritance of regional culture, and personalized proposals for each user, including improved analysis accuracy, enhanced database scalability, and maintenance of cultural diversity. Application fields include household support in general homes, inheritance of traditional culture in local governments, design of experience programs in the tourism industry, and support for regional learning in educational settings.

The collection unit can estimate the user's emotions and adjust the timing of collecting household task data based on the estimated emotions of the user. For example, if the user is feeling stressed, the collection timing is delayed so that data is collected when the user is relaxed. If the user is relaxed, the collection timing can be advanced to collect data efficiently. Furthermore, if the user is in a hurry, the collection timing can be adjusted to reduce the user's burden. By adjusting the collection timing according to the user's emotions, the user's burden can be reduced and data can be collected efficiently. Emotion estimation is realized using, for example, emotion engines or generative AI with emotion estimation functions. Generative AI may include text generation AI (e.g., LLM) or multimodal generative AI, but is not limited to such examples. Some or all of the above-described processing in the collection unit may be performed using AI or without using AI. For example, the collection unit can input the user's emotion data to AI and have the AI perform the timing adjustment for data collection. Specifically, the collection unit samples biometric sensor data (e.g., heart rate time-series tensor, skin conductance value, facial image data, voice tone features, touch pressure logs, etc.) obtained from wearable devices or smartphones every second for emotion estimation, and sends these as time-series tensors or image vectors to the preprocessing unit. The collection unit performs noise removal (e.g., moving average filter), normalization (e.g., Z-score normalization for each biometric indicator), and feature extraction (e.g., heart rate variability analysis, facial feature point extraction, voice spectral feature extraction) in the preprocessing unit to generate structured data such as “heart rate variability,” “facial feature vectors,” and “voice emotion scores.” The collection unit inputs these feature data to, for example, convolutional neural networks (CNNs) for facial emotion classification, recurrent neural networks (RNNs) for time-series biometric data analysis, or Transformer-based multimodal emotion estimation models to estimate the user's emotional state (e.g., stress level, relaxation level, tension level). Examples of input to the AI model include “facial image (128×128 pixel RGB),” “heart rate time-series (1-second intervals×600 samples),” and “voice spectrum (128 dimensions×100 frames).” The AI model generates outputs such as “emotion label (e.g., stress, relaxation, tension),” “emotion score (e.g., stress level 0.7, relaxation level 0.2),” and “estimation confidence (e.g., 0.95).” Examples of output include “stress level 0.8 (high), relaxation level 0.1 (low),” and “emotion label: relaxation, confidence 0.92.” The collection unit uses these emotion estimation outputs to automatically adjust parameters such as “data collection start time,” “collection interval,” and “collection frequency” in a collection timing control module. For example, if the stress level is high, the collection interval is extended to 30 minutes; if the relaxation level is high, data is collected at 5-minute intervals, and so on. As a result, the collection unit dynamically optimizes data collection timing according to the user's emotional state, minimizing the user's burden while collecting necessary data with high accuracy and efficiency. Unlike conventional fixed-time collection or manual adjustment by humans, the present invention analyzes high-dimensional biometric and behavioral data with AI and realizes optimization using unconventional rule-based control or reinforcement learning, thereby achieving improvement effects in computer technology itself, such as improved analysis accuracy, enhanced user experience, and increased system scalability. Application fields include household support in general homes, work support with stress monitoring in nursing care settings, learning data collection according to student emotions in educational settings, and burden-reducing data collection in medical settings.

The collection unit can analyze the user's past household task history at the time of collecting household task data and select a collection method. For example, the collection unit prioritizes the collection of household tasks that the user has frequently performed in the past. The collection unit can also select an efficient collection method based on the user's past household task history. Furthermore, the collection unit can customize the collection method based on the user's past household task history. By analyzing the user's past household task history, an efficient data collection method can be selected. Some or all of the above-described processing in the collection unit may be performed using AI or without using AI. For example, the collection unit can input the user's past household task history to AI and have the AI select the collection method. Specifically, the collection unit refers to a household task history database accumulated for each user (e.g., structured tables of task type, execution date and time, required time, tools used, procedure, work result score, etc.), and extracts the past one month to one year of history as time-series vectors or categorical features. The collection unit inputs these history data to, for example, gradient boosting decision trees (GBDT), recurrent neural networks (RNNs), or Transformer-based history analysis models to automatically extract “frequently performed task types,” “task frequency distribution,” and “time-series changes in task patterns.” Examples of input to the AI model include “time-series of task types for the past 30 days (e.g., cleaning 10 times, laundry 8 times, cooking 15 times),” “vector of required time for tasks (e.g., average cleaning 15 minutes, average laundry 20 minutes),” and “procedure history text (e.g., ‘vacuuming→wiping with a cloth→taking out the trash’).” The AI model generates outputs such as “priority collection task list (e.g., cooking, cleaning),” “recommended collection timing (e.g., cooking in the evening, cleaning in the morning),” and “collection method parameters (e.g., detailed recording for cooking, simplified recording for cleaning).” Examples of output include “focus on collecting cooking data this week,” “detailed recording for cleaning on weekends,” and “laundry can be omitted.” The collection unit uses these outputs to automatically adjust data collection targets, frequency, and level of detail in a collection scheduler or collection mode control module. For example, for users with high frequency of cooking, cooking data is collected in detail each time, and for users with low frequency of cleaning, the collection is switched to simplified recording. Internally, the AI model combines supervised learning (e.g., minimizing loss functions with past collection efficiency-labeled data) and clustering (e.g., user classification by task pattern) to realize history analysis and collection optimization in high-dimensional space, which differs from conventional manual settings and simple rule-based processing. As a result, the collection unit enables flexible data collection according to each user's work tendencies and lifestyle patterns, and brings improvement effects in computer technology itself, such as improved collection efficiency, increased usefulness of the database, and enhanced system scalability. Application fields include household support in general homes, individual work history management in nursing care settings, optimization of work logs in business settings, and data collection based on learning history in educational settings.

The collection unit can perform filtering based on the user's current living situation or areas of interest at the time of collecting household task data. For example, the collection unit collects data based on household tasks that the user is currently interested in. The collection unit can also prioritize the collection of necessary data according to the user's current living situation. Furthermore, the collection unit can filter and collect relevant data based on the user's areas of interest. By filtering data based on the user's current living situation or areas of interest, necessary data can be collected efficiently. Some or all of the above-described processing in the collection unit may be performed using AI or without using AI. For example, the collection unit can input the user's current living situation or areas of interest to AI and have the AI perform the data filtering. Specifically, the collection unit obtains the user's living situation data (e.g., family composition, at-home/outdoor status, health condition, lifestyle rhythm, recent event history, etc.) and areas of interest data (e.g., preferences for cooking, cleaning, DIY, gardening, etc.) from smartphone apps, wearable devices, or user input forms, and sends them as categorical vectors or time-series features to the preprocessing unit. The collection unit inputs these data to, for example, multilayer perceptrons (MLP) or Transformer-based user profile analysis models to automatically determine “current priority household task list,” “collection priority by area of interest,” and “collection mode according to living situation.” Examples of input to the AI model include “family composition vector (e.g., 2 adults, 1 child),” “lifestyle rhythm time-series (e.g., morning type/night type),” and “one-hot vector for areas of interest (e.g., cooking 1, cleaning 0, DIY 1).” The AI model generates outputs such as “priority collection tasks (e.g., cooking, DIY),” “collection detail level (e.g., detailed for cooking, omitted for cleaning),” and “collection timing (e.g., nighttime).” Examples of output include “focus on collecting DIY data this week,” “detailed recording for cooking each time,” and “collect cleaning data only once a month.” The collection unit uses these outputs to automatically adjust data collection targets, frequency, and level of detail in a collection scheduler or filtering module. Internally, the AI model combines supervised learning (e.g., minimizing loss functions with past user satisfaction-labeled data) and reinforcement learning (e.g., optimizing collection strategies to maximize collection efficiency) to realize profile analysis and collection optimization in high-dimensional space, which differs from conventional manual settings and simple rule-based processing. As a result, the collection unit enables flexible data collection according to the user's living situation and areas of interest, and brings improvement effects in computer technology itself, such as improved collection efficiency, increased user satisfaction, and enhanced system scalability. Application fields include household support in general homes, individual needs response in nursing care settings, customization of work content in business settings, and data collection based on students' areas of interest in educational settings.

The collection unit can estimate the user's emotions and determine the priority of household task data to be collected based on the estimated emotions of the user. For example, if the user is feeling stressed, data of low importance is postponed. If the user is relaxed, data of high importance can be collected preferentially. Furthermore, if the user is in a hurry, the priority of data to be collected can be adjusted for efficient collection. By determining the priority of data according to the user's emotions, data can be collected efficiently. Emotion estimation is realized using, for example, emotion engines or generative AI with emotion estimation functions. Generative AI may include text generation AI (e.g., LLM) or multimodal generative AI, but is not limited to such examples. Some or all of the above-described processing in the collection unit may be performed using AI or without using AI. For example, the collection unit can input the user's emotion data to AI and have the AI determine the priority of data. Specifically, the collection unit samples biometric sensor data (e.g., heart rate, skin conductance, facial images, voice tone, touch pressure, etc.) obtained from wearable devices or smartphones every second for emotion estimation, and sends these as time-series tensors or image vectors to the preprocessing unit. The collection unit performs noise removal, normalization, and feature extraction (e.g., heart rate variability analysis, facial feature point extraction, voice spectral feature extraction) in the preprocessing unit to generate structured data such as “heart rate variability,” “facial feature vectors,” and “voice emotion scores.” The collection unit inputs these feature data to, for example, convolutional neural networks (CNNs), recurrent neural networks (RNNs), or Transformer-based multimodal emotion estimation models to estimate the user's emotional state (e.g., stress level, relaxation level, tension level). Examples of input to the AI model include “facial image (128×128 pixel RGB),” “heart rate time-series (1-second intervals×600 samples),” and “voice spectrum (128 dimensions×100 frames).” The AI model generates outputs such as “emotion label (e.g., stress, relaxation, tension),” “emotion score (e.g., stress level 0.7, relaxation level 0.2),” and “estimation confidence (e.g., 0.95).” Examples of output include “stress level 0.8 (high), relaxation level 0.1 (low),” and “emotion label: relaxation, confidence 0.92.” The collection unit uses these emotion estimation outputs to automatically adjust “collection target list,” “priority score,” and “collection order” in a collection target priority control module. For example, if the stress level is high, data of low importance (e.g., auxiliary task data) is postponed, and if the relaxation level is high, data of high importance (e.g., main task data) is collected preferentially. Internally, the AI model combines supervised learning (e.g., minimizing loss functions with past user burden-labeled data) and reinforcement learning (e.g., optimizing priority to maximize collection efficiency) to realize emotion-priority linked control in high-dimensional space, which differs from conventional manual settings and simple rule-based processing. As a result, the collection unit enables flexible data collection according to the user's emotional state, and brings improvement effects in computer technology itself, such as improved collection efficiency, reduced user burden, and enhanced system scalability. Application fields include household support in general homes, work support with stress monitoring in nursing care settings, learning data collection according to student emotions in educational settings, and burden-reducing data collection in medical settings.

The collection unit can preferentially collect highly relevant data by considering the user's geographic location information at the time of collecting household task data. For example, the collection unit preferentially collects household task data related to the user's current location. The collection unit can also select an efficient data collection method based on the user's geographic location information. Furthermore, the collection unit can filter and collect highly relevant data by considering the user's geographic location information. By considering the user's geographic location information, highly relevant data can be collected efficiently. Some or all of the above-described processing in the collection unit may be performed using AI or without using AI. For example, the collection unit can input the user's geographic location information to AI and have the AI perform the data collection. Specifically, the collection unit samples geographic location information such as GPS coordinates (latitude and longitude floating-point vectors), Wi-Fi access point information, beacon signal strength, and indoor location estimation data (e.g., room number or floor information) obtained from smartphones, wearable devices, or stationary sensor units every second, and sends these as time-series vectors or categorical features to the preprocessing unit. The collection unit performs noise removal (e.g., outlier removal by jump detection), normalization (e.g., area classification by geographic clustering), and feature extraction (e.g., area determination, movement pattern extraction) in the preprocessing unit to generate structured data such as “current area ID,” “duration of stay,” and “movement history.” The collection unit inputs these geographic location feature data to, for example, multilayer perceptrons (MLP) or Transformer-based location information analysis models to automatically determine “list of household tasks related to current location,” “collection priority by area,” and “location-dependent collection mode.” Examples of input to the AI model include “GPS coordinate time-series (e.g., latitude/longitude×600 samples),” “Wi-Fi access point ID list,” and “indoor location vector (e.g., room number, floor number).” The AI model generates outputs such as “priority collection tasks (e.g., collect cooking data when in the kitchen, collect cleaning data when in the living room),” “collection detail level (e.g., detailed in the kitchen, simplified in the hallway),” and “collection timing (e.g., only during stay in a specific area).” Examples of output include “currently in the kitchen, so collect cooking data in detail,” “collect only cleaning data in the entrance area,” and “pause data collection in the bedroom.” The collection unit uses these outputs to automatically adjust data collection targets, frequency, and level of detail in a collection scheduler or filtering module. Internally, the AI model combines supervised learning (e.g., minimizing loss functions with past collection efficiency-labeled data) and reinforcement learning (e.g., optimizing location-dependent collection strategies to maximize collection efficiency) to realize location information analysis and collection optimization in high-dimensional space, which differs from conventional manual settings and simple rule-based processing. As a result, the collection unit enables flexible data collection according to the user's current location and movement patterns, and brings improvement effects in computer technology itself, such as improved collection efficiency, increased usefulness of the database, and enhanced system scalability. Application fields include room-specific work data collection for household support in general homes, area-specific work load analysis in nursing care settings, zone-specific optimization of cleaning and cooking procedures in hotels and restaurants, and location-linked household support in smart homes.

The collection unit can analyze the user's social media activity at the time of collecting household task data and collect relevant data. For example, the collection unit collects household task data of interest based on the user's social media activity. The collection unit can also select an efficient data collection method based on the user's social media activity. Furthermore, the collection unit can analyze the user's social media activity and filter and collect relevant data. By analyzing the user's social media activity, relevant data can be collected efficiently. Some or all of the above-described processing in the collection unit may be performed using AI or without using AI. For example, the collection unit can input the user's social media activity to AI and have the AI perform the data collection. Specifically, the collection unit periodically obtains various data such as post texts, images, videos, hashtags, like history, comment history, and follow relationships from multiple social media platforms used by the user (e.g., microblogs, photo sharing services, video posting sites, etc.) via API, and sends them as text vectors, image features, and time-series activity logs to the preprocessing unit. The collection unit performs noise removal (e.g., exclusion of spam posts), normalization (e.g., morphological analysis and normalization of text), and feature extraction (e.g., extraction of household-related keywords, detection of household scenes from images, extraction of action labels from videos) in the preprocessing unit to generate structured data such as “household interest score,” “posting frequency by household category,” and “list of household-related images and videos.” The collection unit inputs these feature data to, for example, Transformer-based natural language processing models or multimodal AI models to automatically determine “current list of household interest areas,” “collection priority according to interest score,” and “social-linked collection mode.” Examples of input to the AI model include “household-related post texts for the past 30 days (e.g., cooking recipes, cleaning tips),” “image vectors of household scenes (e.g., kitchen, living room),” and “frequency distribution of household-related hashtags.” The AI model generates outputs such as “priority collection tasks (e.g., cooking, DIY),” “collection detail level (e.g., detailed for cooking, omitted for cleaning),” and “collection timing (e.g., immediately after household-related posts).” Examples of output include “focus on collecting cooking data this week,” “detailed recording for DIY-related data,” and “collect cleaning data only once a month.” The collection unit uses these outputs to automatically adjust data collection targets, frequency, and level of detail in a collection scheduler or filtering module. Internally, the AI model combines supervised learning (e.g., minimizing loss functions with past household interest-labeled data), clustering (e.g., user classification by household interest pattern), and reinforcement learning (e.g., optimizing strategies to maximize collection efficiency) to realize social media analysis and collection optimization in high-dimensional space, which differs from conventional manual settings and simple rule-based processing. As a result, the collection unit enables flexible data collection according to the user's areas of interest and behavioral tendencies, and brings improvement effects in computer technology itself, such as improved collection efficiency, increased user satisfaction, and enhanced system scalability. Application fields include hobby-linked data collection for household support in general homes, understanding individual needs in nursing care settings, customization of work content in business settings, and data collection based on students' areas of interest in educational settings.

The analysis unit can estimate the user's emotions and adjust the analysis method for household tasks based on the estimated emotions of the user. For example, if the user is feeling stressed, the analysis method is simplified to reduce the user's burden. If the user is relaxed, detailed analysis can be performed to find efficient procedures. Furthermore, if the user is in a hurry, rapid analysis can be performed to propose optimal procedures. By adjusting the analysis method according to the user's emotions, the user's burden can be reduced and analysis can be performed efficiently. Emotion estimation is realized using, for example, emotion engines or generative AI with emotion estimation functions. Generative AI may include text generation AI (e.g., LLM) or multimodal generative AI, but is not limited to such examples. Some or all of the above-described processing in the analysis unit may be performed using AI or without using AI. For example, the analysis unit can input the user's emotion data to AI and have the AI adjust the analysis method. Specifically, the analysis unit samples biometric sensor data (e.g., heart rate time-series tensor, skin conductance value, facial image data, voice tone features, touch pressure logs, etc.) obtained from wearable devices or smartphones every second for emotion estimation, and sends these as time-series tensors or image vectors to the preprocessing unit. The analysis unit performs noise removal (e.g., moving average filter), normalization (e.g., Z-score normalization for each biometric indicator), and feature extraction (e.g., heart rate variability analysis, facial feature point extraction, voice spectral feature extraction) in the preprocessing unit to generate structured data such as “heart rate variability,” “facial feature vectors,” and “voice emotion scores.” The analysis unit inputs these feature data to, for example, convolutional neural networks (CNNs) for facial emotion classification, recurrent neural networks (RNNs) for time-series biometric data analysis, or Transformer-based multimodal emotion estimation models to estimate the user's emotional state (e.g., stress level, relaxation level, tension level). Examples of input to the AI model include “facial image (128×128 pixel RGB),” “heart rate time-series (1-second intervals×600 samples),” and “voice spectrum (128 dimensions×100 frames).” The AI model generates outputs such as “emotion label (e.g., stress, relaxation, tension),” “emotion score (e.g., stress level 0.7, relaxation level 0.2),” and “estimation confidence (e.g., 0.95).” Examples of output include “stress level 0.8 (high), relaxation level 0.1 (low),” and “emotion label: relaxation, confidence 0.92.” The analysis unit uses these emotion estimation outputs to automatically adjust parameters such as “analysis detail level,” “analysis algorithm selection,” and “analysis priority” in an analysis method control module. For example, if the stress level is high, the analysis process is simplified; if the relaxation level is high, detailed multi-stage analysis is performed; and if the user is in a hurry, inference is performed in high-speed mode. Internally, the AI model combines supervised learning (e.g., minimizing loss functions with past user burden-labeled data) and reinforcement learning (e.g., optimizing analysis strategies to maximize analysis efficiency) to realize emotion-analysis linked control in high-dimensional space, which differs from conventional manual settings and simple rule-based processing. As a result, the analysis unit enables flexible optimization of analysis methods according to the user's emotional state, and brings improvement effects in computer technology itself, such as improved analysis efficiency, reduced user burden, and enhanced system scalability. Application fields include household support in general homes, work analysis with stress monitoring in nursing care settings, learning data analysis according to student emotions in educational settings, and burden-reducing data analysis in medical settings.

The analysis unit can adjust the level of detail of analysis based on the importance of household tasks during analysis. For example, the analysis unit performs detailed analysis for household tasks of high importance. The analysis unit can also perform simplified analysis for household tasks of low importance. Furthermore, the analysis unit can adjust the level of detail of analysis according to the importance of household tasks. By adjusting the level of detail of analysis according to the importance of household tasks, analysis can be performed efficiently. Some or all of the above-described processing in the analysis unit may be performed using AI or without using AI. For example, the analysis unit can input the importance of household tasks to AI and have the AI adjust the level of detail of analysis. Specifically, the analysis unit obtains “importance score” and “priority label” (e.g., high, medium, low) for each household task from user settings, past work history, or system estimates, and inputs these to an analysis control module. For tasks of high importance (e.g., meal preparation, nursing care assistance), the analysis unit applies convolutional neural networks (CNNs) or Transformer-based detailed analysis models to analyze multiple features (e.g., procedure time-series, tools used, work environment data) in multiple stages and extract efficiency improvement points and bottlenecks with high accuracy. For tasks of low importance (e.g., daily tidying, auxiliary tasks), the analysis unit applies simple rule-based determination or shallow neural network-based simplified analysis to reduce computational load and analysis time. Examples of input to the AI model include “task type (e.g., cooking, cleaning),” “importance score (e.g., 0.9),” “procedure text,” and “work environment features.” The AI model generates outputs such as “analysis detail level parameter (e.g., detailed/simplified),” “algorithm selection,” and “estimated required time.” Examples of output include “detailed analysis mode for cooking tasks” and “simplified analysis mode for cleaning tasks.” The analysis unit uses these outputs to automatically adjust branching control and resource allocation in the analysis pipeline. Internally, the AI model combines supervised learning (e.g., minimizing loss functions with past analysis accuracy/efficiency-labeled data) and reinforcement learning (e.g., optimizing detail level to maximize analysis efficiency) to realize importance-linked analysis control in high-dimensional space, which differs from conventional manual settings and simple rule-based processing. As a result, the analysis unit optimally allocates computational resources throughout the system, performs high-accuracy analysis for important tasks, and efficient simplified analysis for auxiliary tasks, thereby bringing improvement effects in computer technology itself, such as improved analysis efficiency, enhanced system scalability, and increased user satisfaction. Application fields include household support in general homes, priority analysis of important tasks in nursing care settings, work priority management in business settings, and analysis of important issues in educational settings.

The analysis unit can apply different analysis algorithms according to the category of household tasks during analysis. For example, the analysis unit applies different analysis algorithms for each category, such as cleaning, laundry, and cooking. The analysis unit can also select the optimal analysis algorithm according to the category of household tasks. Furthermore, the analysis unit can apply algorithms for efficient analysis according to each category of household tasks. By applying the optimal analysis algorithm according to the category of household tasks, analysis can be performed efficiently. Some or all of the above-described processing in the analysis unit may be performed using AI or without using AI. For example, the analysis unit can input the category of household tasks to AI and have the AI apply the analysis algorithm. Specifically, the analysis unit obtains “category label” (e.g., cleaning, laundry, cooking, DIY, etc.) for each household task from the work database or user input and inputs it to an analysis algorithm selection module. For the cleaning category, the analysis unit applies convolutional neural networks (CNNs) or recurrent neural networks (RNNs) for time-series analysis to input acceleration sensor time-series and image data, and extracts motion patterns and work intervals with high accuracy. For the laundry category, the analysis unit combines graph neural networks (GNNs) specialized for dependency analysis between steps and tool identification with rule-based determination. For the cooking category, the analysis unit applies multimodal AI models (e.g., Transformer-based) that combine recipe text analysis and image recognition to optimize procedures and manage ingredients. Examples of input to the AI model include “task category (e.g., cooking),” “procedure text,” “image data (e.g., photo during cooking),” and “sensor time-series data.” The AI model generates outputs such as “algorithm ID to be applied,” “analysis parameter set,” and “estimated accuracy.” Examples of output include “apply multimodal analysis algorithm for cooking category” and “apply CNN+RNN analysis for cleaning category.” The analysis unit uses these outputs to automatically control branching and algorithm switching in the analysis pipeline. Internally, the AI model combines supervised learning (e.g., minimizing loss functions with category-specific optimal algorithm-labeled data) and meta-learning (e.g., optimizing algorithm selection for each category) to realize category-linked analysis control in high-dimensional space, which differs from conventional manual selection and simple rule-based processing. As a result, the analysis unit automatically applies the optimal analysis algorithm for each task category, thereby bringing improvement effects in computer technology itself, such as improved analysis accuracy, increased computational efficiency, and enhanced system scalability. Application fields include household support in general homes, analysis by task type in nursing care settings, process optimization by step in business settings, and analysis by issue category in educational settings.

The analysis unit can estimate the user's emotions and determine the priority of analysis based on the estimated emotions of the user. For example, if the user is feeling stressed, analysis of low importance is postponed. If the user is relaxed, analysis of high importance can be performed preferentially. Furthermore, if the user is in a hurry, the priority of analysis can be adjusted for efficient analysis. By determining the priority of analysis according to the user's emotions, analysis can be performed efficiently. Emotion estimation is realized using, for example, emotion engines or generative AI with emotion estimation functions. Generative AI may include text generation AI (e.g., LLM) or multimodal generative AI, but is not limited to such examples. Some or all of the above-described processing in the analysis unit may be performed using AI or without using AI. For example, the analysis unit can input the user's emotion data to AI and have the AI determine the priority of analysis. Specifically, the analysis unit samples biometric sensor data (e.g., heart rate time-series tensor, skin conductance value, facial image data, voice tone features, touch pressure logs, etc.) obtained from wearable devices or smartphones every second for emotion estimation, and sends these as time-series tensors or image vectors to the preprocessing unit. The analysis unit performs noise removal, normalization, and feature extraction (e.g., heart rate variability analysis, facial feature point extraction, voice spectral feature extraction) in the preprocessing unit to generate structured data such as “heart rate variability,” “facial feature vectors,” and “voice emotion scores.” The analysis unit inputs these feature data to, for example, convolutional neural networks (CNNs), recurrent neural networks (RNNs), or Transformer-based multimodal emotion estimation models to estimate the user's emotional state (e.g., stress level, relaxation level, tension level). Examples of input to the AI model include “facial image (128×128 pixel RGB),” “heart rate time-series (1-second intervals×600 samples),” and “voice spectrum (128 dimensions×100 frames).” The AI model generates outputs such as “emotion label (e.g., stress, relaxation, tension),” “emotion score (e.g., stress level 0.7, relaxation level 0.2),” and “estimation confidence (e.g., 0.95).” Examples of output include “stress level 0.8 (high), relaxation level 0.1 (low),” and “emotion label: relaxation, confidence 0.92.” The analysis unit uses these emotion estimation outputs to automatically adjust “analysis target list,” “priority score,” and “analysis order” in an analysis priority control module. For example, if the stress level is high, analysis of low importance (e.g., auxiliary task analysis) is postponed, and if the relaxation level is high, analysis of high importance (e.g., main task analysis) is performed preferentially. Internally, the AI model combines supervised learning (e.g., minimizing loss functions with past user burden-labeled data) and reinforcement learning (e.g., optimizing priority to maximize analysis efficiency) to realize emotion-priority linked analysis control in high-dimensional space, which differs from conventional manual settings and simple rule-based processing. As a result, the analysis unit enables flexible control of analysis priority according to the user's emotional state, and brings improvement effects in computer technology itself, such as improved analysis efficiency, reduced user burden, and enhanced system scalability. Application fields include household support in general homes, work analysis with stress monitoring in nursing care settings, learning data analysis according to student emotions in educational settings, and burden-reducing data analysis in medical settings.

The analysis unit can determine the priority of analysis based on the implementation timing of household tasks during analysis. For example, the analysis unit performs analysis of high importance preferentially based on the implementation timing of household tasks. The analysis unit can also adjust the priority of analysis according to the implementation timing of household tasks. Furthermore, the analysis unit can perform efficient analysis by considering the implementation timing of household tasks. By determining the priority of analysis based on the implementation timing of household tasks, analysis can be performed efficiently. Some or all of the above-described processing in the analysis unit may be performed using AI or without using AI. For example, the analysis unit can input the implementation timing of household tasks to AI and have the AI determine the priority of analysis. Specifically, the analysis unit obtains time-series data such as “scheduled implementation time,” “implementation frequency,” and “recent implementation history” for each household task from the work database, and inputs these as time-series vectors or categorical features to an analysis priority control module. The analysis unit applies convolutional neural networks (CNNs), recurrent neural networks (RNNs), or Transformer-based time-series analysis models to analyze the implementation timing and frequency patterns of tasks, and preferentially targets tasks scheduled for imminent implementation or those with high frequency for analysis. Examples of input to the AI model include “vector of scheduled implementation times for tasks (e.g., cleaning scheduled for Monday, Thursday, Saturday this week),” “frequency distribution of tasks (e.g., cooking three times a day, laundry twice a week),” and “recent implementation history (e.g., last cleaning: two days ago).” The AI model generates outputs such as “analysis priority score,” “analysis order list,” and “recommended analysis timing.” Examples of output include “prioritize analysis of cooking tasks this week,” “detailed analysis of cleaning on weekends,” and “laundry can be omitted.” The analysis unit uses these outputs to automatically adjust analysis targets, order, and level of detail in an analysis scheduler or priority control module. Internally, the AI model combines supervised learning (e.g., minimizing loss functions with past analysis efficiency-labeled data) and reinforcement learning (e.g., optimizing priority to maximize analysis efficiency) to realize time-series linked analysis control in high-dimensional space, which differs from conventional manual settings and simple rule-based processing. As a result, the analysis unit enables flexible control of analysis priority according to the implementation timing of household tasks, and brings improvement effects in computer technology itself, such as improved analysis efficiency, increased user satisfaction, and enhanced system scalability. Application fields include household support in general homes, scheduling analysis of work in nursing care settings, process management in business settings, and analysis linked to assignment submission timing in educational settings.

The analysis unit can adjust the order of analysis based on the relevance of household tasks during analysis. For example, the analysis unit preferentially analyzes household tasks with high relevance. The analysis unit can also adjust the order of analysis based on the relevance of household tasks. Furthermore, the analysis unit can determine the order for efficient analysis of highly relevant household tasks. By adjusting the order of analysis based on the relevance of household tasks, analysis can be performed efficiently. Some or all of the above-described processing in the analysis unit may be performed using AI or without using AI. For example, the analysis unit can input the relevance of household tasks to AI and have the AI adjust the order of analysis. Specifically, the analysis unit obtains structured data such as “dependency matrix between tasks,” “task type,” and “procedure history” for each household task from the work database, and inputs these as graph structures or categorical features to an analysis order control module. The analysis unit applies graph neural networks (GNNs) or Transformer-based dependency analysis models to analyze the relevance and degree of dependency between tasks, and groups highly relevant tasks to prioritize them for analysis. Examples of input to the AI model include “dependency matrix between tasks (e.g., cleaning→laundry →cooking),” “list of task types,” and “procedure history text.” The AI model generates outputs such as “analysis order list,” “relevance score,” and “grouping ID.” Examples of output include “analyze cleaning and laundry simultaneously” and “postpone analysis of cooking.” The analysis unit uses these outputs to automatically adjust analysis targets, order, and grouping in an analysis scheduler or order control module. Internally, the AI model combines supervised learning (e.g., minimizing loss functions with past analysis efficiency-labeled data) and reinforcement learning (e.g., optimizing order to maximize analysis efficiency) to realize relevance-linked analysis control in high-dimensional space, which differs from conventional manual settings and simple rule-based processing. As a result, the analysis unit enables flexible control of analysis order according to the relevance of household tasks, and brings improvement effects in computer technology itself, such as improved analysis efficiency, enhanced system scalability, and increased user satisfaction. Application fields include household support in general homes, work collaboration analysis in nursing care settings, process optimization in business settings, and relevance analysis of assignments in educational settings.

The generation unit can adjust the order of procedures to be generated based on the relevance of household tasks at the time of generation. For example, the generation unit preferentially generates household tasks with high relevance. Furthermore, the generation unit can also adjust the order of procedures to be generated based on the relevance of household tasks. Additionally, the generation unit can determine the order for efficiently generating household tasks with high relevance. By adjusting the order of procedures to be generated based on the relevance of household tasks, procedures can be generated efficiently. Some or all of the above-described processing in the generation unit may be performed using AI, or may be performed without using AI. For example, the generation unit can input the relevance of household tasks to AI and have the AI execute the adjustment of the order of procedures. Specifically, the generation unit inputs structured data such as “task dependency matrix” obtained from a task database, “task type”, and “task procedure history” into a graph neural network (GNN) or Transformer-based dependency analysis model, and analyzes the relevance and degree of dependency among household tasks in a high-dimensional space. For example, the generation unit inputs to the AI model a task dependency matrix (e.g., a 3×3 adjacency matrix such as “cleaning→laundry→cooking”), a task type list (e.g., cleaning, laundry, cooking), and past task procedure history text (e.g., vacuuming→wiping→garbage disposal). The AI model generates outputs such as “optimal procedure order list” (e.g., cleaning and laundry performed simultaneously, cooking postponed), “relevance score” (e.g., relevance between cleaning and laundry: 0.85), and “grouping ID” (e.g., cleaning/laundry group, cooking group). Example outputs include “generate procedures to perform cleaning and laundry simultaneously” and “perform cooking after cleaning and laundry”. Based on these outputs, the generation unit automatically generates optimized household task procedures for each user using a procedure generation algorithm (e.g., dynamic programming, reinforcement learning-based procedure optimization). Internally, the AI model combines supervised learning (e.g., loss function minimization using past task efficiency labeled data) and reinforcement learning (e.g., procedure order optimization to maximize efficiency score), thereby realizing relevance-linked procedure generation in a high-dimensional space, which is different from conventional manual settings or simple rule-based processing. Examples of inputs to the AI model include “task dependency matrix” (e.g., cleaning→laundry→cooking), “task type list”, and “task procedure history text”; the AI model outputs “procedure order list”, “relevance score”, “grouping ID”, etc. These outputs are used in subsequent procedure generation modules as specific procedure proposals such as “Procedure A: cleaning and laundry performed simultaneously, cooking postponed” and “Procedure B: cleaning→cooking→laundry”, and are presented to the user together with evaluation indicators such as efficiency score and required time. Thus, the generation unit automates procedure optimization considering the relevance among household tasks, and can extract efficiency patterns and procedure optimization rules that could not be discovered by conventional manual work or simple rule-based processing, thereby improving analysis accuracy, proposal speed, and system scalability, which are improvements to computer technology itself. Application fields include household support in general homes, collaborative task procedure optimization in nursing care settings, simultaneous multi-process procedure generation in hotels and food service industries, and group task procedure optimization in educational settings.

The provision unit can estimate the user's emotions and adjust the method of providing procedures based on the estimated emotions of the user. For example, if the user is feeling stressed, the provision unit selects a simple provision method. If the user is relaxed, the provision unit can select a detailed provision method. Furthermore, if the user is in a hurry, the provision unit can select a method that enables rapid provision. By adjusting the method of providing procedures according to the user's emotions, the user's burden can be reduced and procedures can be provided efficiently. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the provision unit may be performed using AI, or may be performed without using AI. For example, the provision unit can input the user's emotion data to AI and have the AI execute the adjustment of the provision method. Specifically, the provision unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The provision unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions ×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the provision method control module automatically adjusts parameters such as “provision means (e.g., app notification, email, voice assistant)”, “level of detail of notification (e.g., summary/detailed)”, and “notification timing (e.g., 8 a.m., immediately before task)”. For example, if the stress level is high, a summary version is notified by voice assistant; if the relaxation level is high, a detailed version is notified by app, and so on. Internally, the AI model combines supervised learning (e.g., loss function minimization using past user burden labeled data) and reinforcement learning (e.g., provision strategy optimization to maximize user satisfaction), thereby realizing emotion-linked provision control in a high-dimensional space, which is different from conventional manual settings or simple rule-based processing. As a result, the provision unit enables flexible optimization of provision methods according to the user's emotional state, and demonstrates improvements to computer technology itself, such as increased proposal speed, reduced user burden, and enhanced system scalability. Application fields include household support in general homes, task support with stress monitoring in nursing care settings, provision of learning procedures according to student emotions in educational settings, and provision of procedures to reduce patient burden in medical settings.

The provision unit can select a provision method by referring to the user's past procedure usage history at the time of provision. For example, the provision unit selects the optimal provision method based on procedures previously used by the user. Furthermore, the provision unit can select an efficient provision method from the user's past procedure usage history. Additionally, the provision unit can analyze the user's past procedure usage history and propose the optimal provision method. By referring to the user's past procedure usage history, the optimal provision method can be selected. Some or all of the above-described processing in the provision unit may be performed using AI, or may be performed without using AI. For example, the provision unit can input the user's past procedure usage history to AI and have the AI execute the selection of the provision method. Specifically, the provision unit refers to a procedure usage history database accumulated for each user (e.g., procedure type, usage date and time, usage device, notification means, usage result score, etc. in a structured table), and extracts one month to one year of history as time-series vectors or categorical features. The provision unit inputs these history data into, for example, a gradient boosting decision tree (GBDT), recurrent neural network (RNN), or Transformer-based history analysis model to automatically extract “frequent procedure types”, “usage frequency distribution”, and “time-series changes in usage patterns”. Example inputs to the AI model include “procedure type time-series for the past 30 days (e.g., cleaning procedure 10 times, cooking procedure 15 times)”, “usage device vector (e.g., smartphone 8 times, PC 2 times)”, and “notification means history (e.g., app notification 12 times, email 3 times)”. The AI model generates outputs such as “recommended provision means (e.g., app notification, voice assistant)”, “notification timing (e.g., 8 a.m., immediately before task)”, and “level of detail of notification (e.g., summary/detailed)”. Example outputs include “notify detailed procedures via smartphone app at 8 a.m.” and “read out summary procedures via voice assistant immediately before task”. Based on these outputs, the provision scheduler or notification control module automatically adjusts provision means, timing, and content. Internally, the AI model combines supervised learning (e.g., loss function minimization using past user satisfaction labeled data) and clustering (e.g., user classification by usage pattern), thereby realizing high-dimensional history analysis and provision optimization, which is different from conventional manual settings or simple rule-based processing. As a result, the provision unit enables flexible procedure provision according to each user's usage tendencies and lifestyle patterns, and demonstrates improvements to computer technology itself, such as increased provision efficiency, improved user satisfaction, and enhanced system scalability. Application fields include household support in general homes, individual task history management in nursing care settings, task procedure optimization in business settings, and provision of procedures based on learning history in educational settings.

The provision unit can customize the means of providing procedures based on the user's current living situation at the time of provision. For example, the provision unit selects the optimal provision means according to the user's current living situation. Furthermore, the provision unit can customize the means of providing procedures based on the user's living situation. Additionally, the provision unit can propose efficient provision means by considering the user's current living situation. By customizing the means of providing procedures based on the user's current living situation, procedures can be provided efficiently. Some or all of the above-described processing in the provision unit may be performed using AI, or may be performed without using AI. For example, the provision unit can input the user's current living situation to AI and have the AI execute the customization of the provision means. Specifically, the provision unit obtains the user's living situation data (e.g., family composition, at-home/out status, health condition, lifestyle rhythm, recent event history, etc.) from smartphone apps, wearable devices, or user input forms, and sends them as categorical vectors or time-series features to a preprocessing unit. The provision unit inputs these data into a multilayer perceptron (MLP) or Transformer-based user profile analysis model to automatically determine “current priority provision means”, “notification priority by living situation”, and “situation-dependent provision mode”. Example inputs to the AI model include “family composition vector (e.g., 2 adults, 1child)”, “lifestyle rhythm time-series (e.g., morning type/night type)”, and “health condition label (e.g., good/fatigue/sick)”. The AI model generates outputs such as “recommended provision means (e.g., voice assistant, app notification, printed guide)”, “notification timing (e.g., nighttime, weekend)”, and “level of detail of notification (e.g., summary/detailed)”. Example outputs include “provide summary procedures via voice assistant at night” and “mail printed guide on weekends”. Based on these outputs, the provision scheduler or notification control module automatically adjusts provision means, timing, and content. Internally, the AI model combines supervised learning (e.g., loss function minimization using past user satisfaction labeled data) and reinforcement learning (e.g., provision strategy optimization to maximize provision efficiency), thereby realizing high-dimensional profile analysis and provision optimization, which is different from conventional manual settings or simple rule-based processing. As a result, the provision unit enables flexible procedure provision according to the user's living situation, and demonstrates improvements to computer technology itself, such as increased provision efficiency, improved user satisfaction, and enhanced system scalability. Application fields include household support in general homes, individual needs response in nursing care settings, task content customization in business settings, and provision of procedures based on students' living situations in educational settings.

The provision unit can estimate the user's emotions and determine the priority of providing procedures based on the estimated emotions of the user. For example, if the user is feeling stressed, the provision unit postpones procedures of low importance. If the user is relaxed, the provision unit can prioritize the provision of procedures of high importance. Furthermore, if the user is in a hurry, the provision unit can adjust the priority of procedures to be provided for efficient provision. By determining the priority of providing procedures according to the user's emotions, procedures can be provided efficiently. Emotion estimation is realized, for example, by using an emotion engine or generative AI with emotion estimation functions. Generative AI may include text generation AI (e.g., LLM) or multimodal generative AI, but is not limited to these examples. Some or all of the above-described processing in the provision unit may be performed using AI, or may be performed without using AI. For example, the provision unit can input the user's emotion data to AI and have the AI execute the determination of provision priority. Specifically, the provision unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal, normalization, and feature extraction (e.g., heart rate variability analysis, facial feature point extraction, voice spectral feature extraction) to generate structured data such as “heart rate variability”, “facial feature vectors”, and “voice emotion scores”. The provision unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the provision priority control module automatically adjusts “provision target list”, “priority score”, and “provision order”. For example, if the stress level is high, procedures of low importance (e.g., auxiliary task procedures) are postponed; if the relaxation level is high, procedures of high importance (e.g., main task procedures) are prioritized, and so on. Internally, the AI model combines supervised learning (e.g., loss function minimization using past user burden labeled data) and reinforcement learning (e.g., priority optimization to maximize provision efficiency), thereby realizing emotion-linked priority provision control in a high-dimensional space, which is different from conventional manual settings or simple rule-based processing. As a result, the provision unit enables flexible control of procedure provision priority according to the user's emotional state, and demonstrates improvements to computer technology itself, such as increased provision efficiency, reduced user burden, and enhanced system scalability. Application fields include household support in general homes, task support with stress monitoring in nursing care settings, provision of learning procedures according to student emotions in educational settings, and provision of procedures to reduce patient burden in medical settings.

The provision unit can provide procedures by considering the user's geographic location information at the time of provision. For example, the provision unit prioritizes procedures related to the user's current location. Furthermore, the provision unit can provide efficient procedures based on the user's geographic location information. Additionally, the provision unit can provide highly relevant procedures by considering the user's geographic location information. By considering the user's geographic location information, optimal procedures can be provided efficiently. Some or all of the above-described processing in the provision unit may be performed using AI, or may be performed without using AI. For example, the provision unit can input the user's geographic location information to AI and have the AI execute the provision of procedures. Specifically, the provision unit samples geographic location information such as GPS coordinates (latitude/longitude floating-point vectors), Wi-Fi access point information, beacon signal strength, and indoor location estimation data (e.g., room number or floor information) obtained from smartphones, wearable devices, or stationary sensor units every second, and sends these as time-series vectors or categorical features to a preprocessing unit. The preprocessing unit performs noise removal (e.g., outlier removal by jump detection), normalization (e.g., area classification by geographic clustering), and feature extraction (e.g., stay area determination, movement pattern extraction) to generate structured data such as “current area ID”, “stay time”, and “movement history”. The provision unit inputs these geographic location feature data into a multilayer perceptron (MLP) or Transformer-based location information analysis model to automatically determine “procedure list related to current location”, “provision priority by area”, and “location-dependent provision mode”. Example inputs to the AI model include “GPS coordinate time-series (e.g., latitude/longitude×600 samples)”, “Wi-Fi access point ID list”, and “indoor location vector (e.g., room number, floor number)”. The AI model generates outputs such as “priority procedures to be provided (e.g., cooking procedures when in the kitchen, cleaning procedures when in the living room)”, “level of detail of provision (e.g., detailed in the kitchen, simplified in the hallway)”, and “provision timing (e.g., only when staying in a specific area)”. Example outputs include “provide detailed cooking procedures because currently in the kitchen”, “provide only cleaning procedures in the entrance area”, and “suspend procedure provision in the bedroom”. Based on these outputs, the provision scheduler or filtering module automatically adjusts provision targets, frequency, and level of detail. Internally, the AI model combines supervised learning (e.g., loss function minimization using past provision efficiency labeled data) and reinforcement learning (e.g., location-dependent provision strategy optimization to maximize provision efficiency), thereby realizing high-dimensional geographic location information analysis and provision optimization, which is different from conventional manual settings or simple rule-based processing. As a result, the provision unit enables flexible procedure provision according to the user's current location and movement patterns, and demonstrates improvements to computer technology itself, such as increased provision efficiency, improved user satisfaction, and enhanced system scalability. Application fields include room-specific procedure provision for household support in general homes, area-specific task support in nursing care settings, zone-specific cleaning/cooking procedure provision in hotels and food service industries, and location-linked household support in smart homes.

The provision unit can analyze the user's social media activity at the time of provision and propose means of providing procedures. For example, the provision unit provides procedures of interest based on the user's social media activity. Furthermore, the provision unit can select efficient provision means based on the user's social media activity. Additionally, the provision unit can analyze the user's social media activity and provide relevant procedures. By analyzing the user's social media activity, relevant procedures can be provided efficiently. Some or all of the above-described processing in the provision unit may be performed using AI, or may be performed without using AI. For example, the provision unit can input the user's social media activity to AI and have the AI execute the proposal of means of providing procedures. Specifically, the provision unit periodically obtains various data such as post text, images, videos, hashtags, like history, comment history, and follow relationships from multiple social media platforms used by the user (e.g., microblogs, photo sharing services, video posting sites, etc.) via API, and sends these as text vectors, image features, and time-series activity logs to a preprocessing unit. The preprocessing unit performs noise removal (e.g., exclusion of spam posts), normalization (e.g., morphological analysis and normalization of text), and feature extraction (e.g., extraction of household-related keywords, detection of household scenes from images, extraction of action labels from videos) to generate structured data such as “household interest score”, “posting frequency by household category”, and “list of household-related images/videos”. The provision unit inputs these feature data into a Transformer-based natural language processing model or multimodal AI model to automatically determine “current household interest field list”, “provision priority according to interest level”, and “social-linked provision mode”. Example inputs to the AI model include “household-related post text for the past 30 days (e.g., cooking recipes, cleaning tips)”, “household scene image vectors (e.g., kitchen, living room)”, and “frequency distribution of household-related hashtags”. The AI model generates outputs such as “priority procedures to be provided (e.g., cooking, DIY)”, “level of detail of provision (e.g., detailed for cooking, omitted for cleaning)”, and “provision timing (e.g., immediately after household-related posts)”. Example outputs include “focus on providing cooking procedures this week”, “notify DIY-related procedures in detail”, and “provide cleaning procedures only once a month”. Based on these outputs, the provision scheduler or filtering module automatically adjusts provision targets, frequency, and level of detail. Internally, the AI model combines supervised learning (e.g., loss function minimization using past household interest labeled data), clustering (e.g., user classification by household interest pattern), and reinforcement learning (e.g., strategy optimization to maximize provision efficiency), thereby realizing high-dimensional social media analysis and provision optimization, which is different from conventional manual settings or simple rule-based processing. As a result, the provision unit enables flexible procedure provision according to the user's interest fields and behavioral tendencies, and demonstrates improvements to computer technology itself, such as increased provision efficiency, improved user satisfaction, and enhanced system scalability. Application fields include hobby-linked procedure provision for household support in general homes, individual needs identification in nursing care settings, task content customization in business settings, and provision of procedures based on students' interest fields in educational settings.

The system according to the embodiment is not limited to the above-described examples, and various modifications are possible, for example, as follows. Specifically, the system can be applied to various fields, such as optimization of tasks in nursing care settings, process management in business settings, optimization of learning procedures in educational settings, and optimization of patient care procedures in medical settings, in addition to supporting the efficiency of household tasks. The system can flexibly change the type and configuration of AI models, and can select the optimal algorithm according to the application and data characteristics, such as convolutional neural networks (CNN), recurrent neural networks (RNN), graph neural networks (GNN), Transformer-based models, gradient boosting decision trees (GBDT), and multilayer perceptrons (MLP). Furthermore, various hardware can be used in combination as data collection devices, such as wearable devices, smartphones, stationary sensor units, smart appliances, and IoT devices. In addition, the system can integrally analyze various types of multimodal data, such as accelerometer sensors, voice, images, videos, touch operation logs, location information, biometric sensors, and social media activity logs. The learning methods for AI models can also be combined, such as supervised learning, reinforcement learning, meta-learning, transfer learning, and clustering, to improve accuracy and versatility. The system configuration can combine cloud servers, edge devices, and distributed processing clusters to support real-time processing and large-scale data analysis. These flexible configuration changes enable high-precision and high-efficiency task optimization and procedure proposals that could not be realized by conventional manual work or simple rule-based processing, and demonstrate improvements to computer technology itself, such as improved analysis accuracy, increased proposal speed, enhanced system scalability, and improved user satisfaction. Application fields include household support in general homes, task efficiency improvement in nursing care settings, process optimization in business settings, learning support in educational settings, optimization of care procedures in medical settings, support for traditional culture succession in local governments, and design of experience programs in the tourism industry.

The analysis unit can estimate the user's emotions and preferentially analyze efficiency improvement points for household tasks based on the estimated emotions of the user. For example, if the user is feeling stressed, the analysis unit preferentially analyzes efficiency improvement points to reduce stress. If the user is relaxed, the analysis unit can analyze detailed efficiency improvement points. Furthermore, if the user is in a hurry, the analysis unit can quickly analyze and propose optimal efficiency improvement points. By adjusting the analysis of efficiency improvement points according to the user's emotions, the user's burden can be reduced and household tasks can be performed efficiently. Specifically, the analysis unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The analysis unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions ×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the efficiency improvement point analysis control module automatically adjusts parameters such as “analysis priority score”, “efficiency improvement point list”, and “analysis level of detail”. For example, if the stress level is high, “efficiency improvement points for reducing task burden (e.g., procedure simplification, automatic selection of tools)” are preferentially extracted; if the relaxation level is high, “detailed efficiency improvement points (e.g., subdivision of task procedures, optimization of time allocation)” are analyzed in multiple stages; and if the user is in a hurry, “immediately executable efficiency improvement points (e.g., time-saving procedures, parallel tasks)” are proposed quickly. Internally, the AI model combines supervised learning (e.g., loss function minimization using past user burden labeled data) and reinforcement learning (e.g., priority optimization of points to maximize efficiency score), thereby realizing emotion-linked efficiency improvement point analysis in a high-dimensional space, which is different from conventional manual settings or simple rule-based processing. As a result, the analysis unit enables flexible analysis of efficiency improvement points according to the user's emotional state, and demonstrates improvements to computer technology itself, such as improved analysis accuracy, reduced user burden, and enhanced system scalability. Application fields include household support in general homes, task efficiency improvement with stress monitoring in nursing care settings, process optimization in business settings, analysis of learning efficiency improvement points according to student emotions in educational settings, and efficiency improvement of tasks to reduce patient burden in medical settings.

The collection unit can monitor the user's health condition and adjust the timing of collecting household task data based on the health condition. For example, if the user is tired, the collection timing is delayed and data is collected after the user has rested. If the user is energetic, the collection timing can be advanced to collect data efficiently. Furthermore, if the user is sick, the collection timing can be adjusted to reduce the user's burden. By adjusting the collection timing according to the user's health condition, the user's burden can be reduced and data can be collected efficiently. Specifically, the collection unit samples biometric sensor data (e.g., heart rate, blood oxygen saturation, body temperature, step count, sleep time, activity level, skin conductance response value, etc.) obtained from wearable devices or smartphones every minute, and sends these as time-series tensors or numerical vectors to a preprocessing unit. The preprocessing unit performs noise removal (e.g., outlier removal), normalization (e.g., Z-score normalization of each biometric indicator), and feature extraction (e.g., fatigue estimation, activity level change analysis, sleep quality evaluation) to generate structured data such as “fatigue score”, “activity level vector”, and “health condition label”. The collection unit inputs these feature data into a recurrent neural network (RNN) or Transformer-based health condition estimation model to estimate the user's health condition (e.g., energetic, fatigued, sick, recovering). Example inputs to the AI model include “heart rate time-series (1-minute intervals×1440 samples)”, “sleep time vector (e.g., sleep time for the past 7 days)”, and “activity level vector (e.g., daily step count)”. The AI model generates outputs such as “health condition label (e.g., energetic, fatigued, sick)”, “health score (e.g., fatigue level 0.8, health level 0.2)”, and “estimation confidence (e.g., 0.93)”. Example outputs include “health condition: fatigued, confidence 0.91” and “health condition: sick, confidence 0.95”. Based on these health condition estimation outputs, the collection timing control module automatically adjusts parameters such as “data collection start time”, “collection interval”, and “collection frequency”. For example, if the fatigue level is high, the collection interval is extended to one hour; if the user is energetic, data is collected at 10-minute intervals; and if the user is sick, collection is suspended or limited to a minimum, and so on. Internally, the AI model combines supervised learning (e.g., loss function minimization using past health condition labeled data) and reinforcement learning (e.g., collection strategy optimization to minimize user burden), thereby realizing health condition-linked collection control in a high-dimensional space, which is different from conventional manual settings or simple rule-based processing. As a result, the collection unit enables flexible control of data collection timing according to the user's health condition, and demonstrates improvements to computer technology itself, such as improved collection efficiency, reduced user burden, and enhanced system scalability. Application fields include household support in general homes, task support with health monitoring in nursing care settings, data collection to reduce patient burden in medical settings, and data collection linked to worker health management in business settings.

The generation unit can estimate the user's emotions and customize household task procedures based on the estimated emotions of the user. For example, if the user is feeling stressed, the generation unit proposes simple procedures. If the user is relaxed, the generation unit can propose detailed procedures. Furthermore, if the user is in a hurry, the generation unit can propose procedures that can be executed quickly. By customizing procedures according to the user's emotions, the user's burden can be reduced and household tasks can be performed efficiently. Specifically, the generation unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The generation unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions ×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the procedure generation control module automatically adjusts parameters such as “procedure level of detail”, “procedure simplification parameter”, and “execution priority”. For example, if the stress level is high, “procedure simplification (e.g., reduction of number of steps, automatic selection of tools)” is prioritized; if the relaxation level is high, “detailed procedures (e.g., breakdown of each step, clarification of points to note)” are generated; and if the user is in a hurry, “immediately executable procedures (e.g., time-saving procedures, parallel tasks)” are proposed. Internally, the AI model combines supervised learning (e.g., loss function minimization using past user burden labeled data) and reinforcement learning (e.g., procedure generation optimization to maximize efficiency score), thereby realizing emotion-linked procedure generation in a high-dimensional space, which is different from conventional manual settings or simple rule-based processing. As a result, the generation unit enables flexible procedure customization according to the user's emotional state, and demonstrates improvements to computer technology itself, such as increased proposal speed, reduced user burden, and enhanced system scalability. Application fields include household support in general homes, procedure generation with stress monitoring in nursing care settings, process optimization in business settings, procedure generation according to student emotions in educational settings, and procedure generation to reduce patient burden in medical settings.

The provision unit can analyze the user's past household task data and optimize the method of providing procedures based on past data. For example, the provision unit preferentially provides procedures that the user has performed efficiently in the past. Furthermore, the provision unit can select the optimal provision method from the user's past data. Additionally, the provision unit can customize the method of providing procedures based on the user's past data. By utilizing the user's past data, optimal procedures can be provided efficiently. Specifically, the provision unit refers to a household task database accumulated for each user (e.g., task type, execution date and time, required time, tools used, task procedures, task result score, usage device, notification means, usage result feedback, etc. in a structured table), and extracts one month to one year of history as time-series vectors or categorical features. The provision unit inputs these history data into a gradient boosting decision tree (GBDT), recurrent neural network (RNN), or Transformer-based history analysis model to automatically extract “frequent procedure types”, “usage frequency distribution”, “time-series changes in usage patterns”, and “user satisfaction estimation”. Example inputs to the AI model include “procedure type time-series for the past 30 days (e.g., cleaning procedure 10 times, cooking procedure 15 times)”, “usage device vector (e.g., smartphone 8 times, PC 2 times)”, “notification means history (e.g., app notification 12 times, email 3 times)”, and “usage result score (e.g., satisfaction 0.9)”. The AI model generates outputs such as “recommended provision means (e.g., app notification, voice assistant)”, “notification timing (e.g., 8 a.m., immediately before task)”, “level of detail of notification (e.g., summary/detailed)”, and “priority procedure list”. Example outputs include “notify detailed procedures via smartphone app at 8 a.m.”, “read out summary procedures via voice assistant immediately before task”, and “prioritize provision of procedures that received high ratings in the past”. Based on these outputs, the provision scheduler or notification control module automatically adjusts provision means, timing, content, and priority. Internally, the AI model combines supervised learning (e.g., loss function minimization using past user satisfaction labeled data), clustering (e.g., user classification by usage pattern), and reinforcement learning (e.g., provision strategy optimization to maximize provision efficiency), thereby realizing high-dimensional history analysis and provision optimization, which is different from conventional manual settings or simple rule-based processing. As a result, the provision unit enables flexible procedure provision according to each user's usage tendencies and lifestyle patterns, and demonstrates improvements to computer technology itself, such as increased provision efficiency, improved user satisfaction, and enhanced system scalability. Application fields include household support in general homes, individual task history management in nursing care settings, task procedure optimization in business settings, provision of procedures based on learning history in educational settings, and provision of procedures linked to patient care history in medical settings.

The analysis unit can estimate the user's emotions and preferentially analyze efficiency improvement points for household tasks based on the estimated emotions of the user. For example, if the user is feeling stressed, the analysis unit preferentially analyzes efficiency improvement points to reduce stress. If the user is relaxed, the analysis unit can analyze detailed efficiency improvement points. Furthermore, if the user is in a hurry, the analysis unit can quickly analyze and propose optimal efficiency improvement points. By adjusting the analysis of efficiency improvement points according to the user's emotions, the user's burden can be reduced and household tasks can be performed efficiently. Specifically, the analysis unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The analysis unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions ×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the efficiency improvement point analysis control module automatically adjusts parameters such as “analysis priority score”, “efficiency improvement point list”, and “analysis level of detail”. For example, if the stress level is high, “efficiency improvement points for reducing task burden (e.g., procedure simplification, automatic selection of tools)” are preferentially extracted; if the relaxation level is high, “detailed efficiency improvement points (e.g., subdivision of task procedures, optimization of time allocation)” are analyzed in multiple stages; and if the user is in a hurry, “immediately executable efficiency improvement points (e.g., time-saving procedures, parallel tasks)” are proposed quickly. Internally, the AI model combines supervised learning (e.g., loss function minimization using past user burden labeled data) and reinforcement learning (e.g., priority optimization of points to maximize efficiency score), thereby realizing emotion-linked efficiency improvement point analysis in a high-dimensional space, which is different from conventional manual settings or simple rule-based processing. As a result, the analysis unit enables flexible analysis of efficiency improvement points according to the user's emotional state, and demonstrates improvements to computer technology itself, such as improved analysis accuracy, reduced user burden, and enhanced system scalability. Application fields include household support in general homes, task efficiency improvement with stress monitoring in nursing care settings, process optimization in business settings, analysis of learning efficiency improvement points according to student emotions in educational settings, and efficiency improvement of tasks to reduce patient burden in medical settings.

The collection unit can monitor the user's lifestyle rhythm and adjust the timing of collecting household task data based on the lifestyle rhythm. For example, if the user is a night person, the collection timing is set to nighttime. If the user is a morning person, the collection timing can be set to morning. Furthermore, by adjusting the collection timing according to the user's lifestyle rhythm, data can be collected efficiently. By adjusting the collection timing according to the user's lifestyle rhythm, data can be collected efficiently. Specifically, the collection unit samples activity data (e.g., step count, activity intensity, sleep time, wake-up/bedtime, meal time, app usage logs, etc.) obtained from wearable devices or smartphones every minute, and sends these as time-series tensors or numerical vectors to a preprocessing unit. The preprocessing unit performs noise removal (e.g., outlier removal), normalization (e.g., Z-score normalization of each indicator), and feature extraction (e.g., activity pattern analysis, sleep rhythm estimation, lifestyle cycle classification) to generate structured data such as “activity peak time”, “sleep rhythm label”, and “lifestyle rhythm score”. The collection unit inputs these feature data into a recurrent neural network (RNN) or Transformer-based lifestyle rhythm estimation model to estimate the user's lifestyle rhythm (e.g., morning type, night type, irregular type). Example inputs to the AI model include “activity amount time-series (1-minute intervals×1440 samples)”, “sleep time vector (e.g., sleep time for the past 7 days)”, and “app usage time distribution”. The AI model generates outputs such as “lifestyle rhythm label (e.g., morning type, night type, irregular type)”, “recommended collection timing (e.g., 6 a.m., 10 p.m.)”, and “estimation confidence (e.g., 0.94)”. Example outputs include “lifestyle rhythm: night type, recommended collection timing: 10 p.m.” and “lifestyle rhythm: morning type, recommended collection timing: 6 a.m.”. Based on these lifestyle rhythm estimation outputs, the collection timing control module automatically adjusts parameters such as “data collection start time”, “collection interval”, and “collection frequency”. Internally, the AI model combines supervised learning (e.g., loss function minimization using past lifestyle rhythm labeled data) and reinforcement learning (e.g., collection strategy optimization to maximize collection efficiency), thereby realizing lifestyle rhythm-linked collection control in a high-dimensional space, which is different from conventional manual settings or simple rule-based processing. As a result, the collection unit enables flexible control of data collection timing according to the user's lifestyle rhythm, and demonstrates improvements to computer technology itself, such as improved collection efficiency, reduced user burden, and enhanced system scalability. Application fields include household support in general homes, task support linked to lifestyle rhythm in nursing care settings, data collection linked to patient lifestyle rhythm in medical settings, and shift-linked data collection in business settings.

The provision unit can estimate the user's emotions and adjust the method of providing procedures based on the estimated emotions of the user. For example, if the user is feeling stressed, the provision unit selects a simple provision method. If the user is relaxed, the provision unit can select a detailed provision method. Furthermore, if the user is in a hurry, the provision unit can select a method that enables rapid provision. By adjusting the method of providing procedures according to the user's emotions, the user's burden can be reduced and procedures can be provided efficiently. Specifically, the provision unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The provision unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the provision method control module automatically adjusts parameters such as “provision means (e.g., app notification, email, voice assistant)”, “level of detail of notification (e.g., summary/detailed)”, and “notification timing (e.g., 8 a.m., immediately before task)”. For example, if the stress level is high, a summary version is notified by voice assistant; if the relaxation level is high, a detailed version is notified by app; and if the user is in a hurry, immediate notification is selected, and so on. Internally, the AI model combines supervised learning (e.g., loss function minimization using past user burden labeled data) and reinforcement learning (e.g., provision strategy optimization to maximize user satisfaction), thereby realizing emotion-linked provision control in a high-dimensional space, which is different from conventional manual settings or simple rule-based processing. As a result, the provision unit enables flexible optimization of provision methods according to the user's emotional state, and demonstrates improvements to computer technology itself, such as increased proposal speed, reduced user burden, and enhanced system scalability. Application fields include household support in general homes, task support with stress monitoring in nursing care settings, provision of learning procedures according to student emotions in educational settings, and provision of procedures to reduce patient burden in medical settings.

The collection unit can adjust the method of collecting household task data by considering the user's family composition. For example, if the family is large, the collection unit collects data for all family members. If the family is small, the collection unit can collect individual data. Furthermore, by customizing the collection method according to the family composition, data can be collected efficiently. By adjusting the collection method according to the family composition, data can be collected efficiently. Specifically, the collection unit obtains the user's family composition data (e.g., number of family members, age composition, cohabitation/separation status, role sharing among family members, health condition, etc.) from smartphone apps, wearable devices, or user input forms, and sends them as categorical vectors or numerical vectors to a preprocessing unit. The collection unit inputs these data into a multilayer perceptron (MLP) or Transformer-based family composition analysis model to automatically determine “collection target list by family unit”, “individual collection priority”, and “collection mode by family composition”. Example inputs to the AI model include “family member number vector (e.g., 2 adults, 2 children)”, “age composition vector (e.g., adult 40 years old, child 10 years old/8 years old)”, and “role sharing label (e.g., cleaning in charge, cooking in charge)”. The AI model generates outputs such as “collection target (e.g., all family members, specific members)”, “level of detail of collection (e.g., detailed for all, simplified for individuals)”, and “collection timing (e.g., when all family members are at home)”. Example outputs include “collect detailed data for all family members”, “collect individual data for children only”, and “collect data for adults only once a week”. Based on these outputs, the collection scheduler or collection mode control module automatically adjusts collection target, frequency, and level of detail. Internally, the AI model combines supervised learning (e.g., loss function minimization using past family composition labeled data), clustering (e.g., classification of collection patterns by family composition), and reinforcement learning (e.g., collection strategy optimization to maximize collection efficiency), thereby realizing family composition-linked collection control in a high-dimensional space, which is different from conventional manual settings or simple rule-based processing. As a result, the collection unit enables flexible optimization of data collection methods according to family composition, and demonstrates improvements to computer technology itself, such as improved collection efficiency, reduced user burden, and enhanced system scalability. Application fields include household support in general homes, family unit task management in nursing care settings, family composition-linked data collection in medical settings, and collection of learning data according to home environment in educational settings.

The generation unit can estimate the user's emotions and customize household task procedures based on the estimated emotions of the user. For example, if the user is feeling stressed, the generation unit proposes simple procedures. If the user is relaxed, the generation unit can propose detailed procedures. Furthermore, if the user is in a hurry, the generation unit can propose procedures that can be executed quickly. By customizing procedures according to the user's emotions, the user's burden can be reduced and household tasks can be performed efficiently. Specifically, the generation unit samples biometric sensor data (e.g., heart rate time-series tensor, skin conductance response value, facial image data, voice tone features, touch operation pressure logs, etc.) obtained from wearable devices or smartphones every second, and sends these as time-series tensors or image vectors to a preprocessing unit. The preprocessing unit performs noise removal (e.g., moving average filter), normalization (e.g., Z-score normalization of each biometric indicator), and feature extraction (e.g., heart rate variability analysis, facial feature point extraction, voice spectral feature extraction) to generate structured data such as “heart rate variability”, “facial feature vectors”, and “voice emotion scores”. The generation unit inputs these feature data into a convolutional neural network (CNN), recurrent neural network (RNN), or Transformer-based multimodal emotion estimation model to estimate the user's emotional state (e.g., stress level, relaxation level, tension level). Example inputs to the AI model include “facial image (128×128 pixel RGB)”, “heart rate time-series (1-second intervals×600 samples)”, and “voice spectrum (128 dimensions ×100 frames)”. The AI model generates outputs such as “emotion label (e.g., stress, relaxation, tension)”, “emotion score (e.g., stress level 0.7, relaxation level 0.2)”, and “estimation confidence (e.g., 0.95)”. Example outputs include “stress level 0.8 (high), relaxation level 0.1 (low)” and “emotion label: relaxation, confidence 0.92”. Based on these emotion estimation outputs, the procedure generation control module automatically adjusts parameters such as “procedure level of detail”, “procedure simplification parameter”, and “execution priority”. For example, if the stress level is high, “procedure simplification (e.g., reduction of number of steps, automatic selection of tools)” is prioritized; if the relaxation level is high, “detailed procedures (e.g., breakdown of each step, clarification of points to note)” are generated; and if the user is in a hurry, “immediately executable procedures (e.g., time-saving procedures, parallel tasks)” are proposed. Internally, the AI model combines supervised learning (e.g., loss function minimization using past user burden labeled data) and reinforcement learning (e.g., procedure generation optimization to maximize efficiency score), thereby realizing emotion-linked procedure generation in a high-dimensional space, which is different from conventional manual settings or simple rule-based processing. As a result, the generation unit enables flexible procedure customization according to the user's emotional state, and demonstrates improvements to computer technology itself, such as increased proposal speed, reduced user burden, and enhanced system scalability. Application fields include household support in general homes, procedure generation with stress monitoring in nursing care settings, process optimization in business settings, procedure generation according to student emotions in educational settings, and procedure generation to reduce patient burden in medical settings.

The provision unit can customize the method of providing procedures by considering the user's hobbies and interests. For example, if the user is interested in cooking, the provision unit preferentially provides procedures related to cooking. If the user is interested in cleaning, the provision unit can preferentially provide procedures related to cleaning. Furthermore, by customizing the method of providing procedures according to the user's hobbies and interests, procedures can be provided efficiently. By customizing the method of providing procedures according to the user's hobbies and interests, procedures can be provided efficiently. Specifically, the provision unit obtains the user's hobby and interest data (e.g., preferences for cooking, cleaning, DIY, gardening, interior design, pet care, etc.) from smartphone apps, wearable devices, user input forms, or social media activity logs, and sends them as categorical vectors or one-hot vectors to a preprocessing unit. The provision unit inputs these data into a multilayer perceptron (MLP) or Transformer-based user profile analysis model to automatically determine “priority procedure list by hobby/interest”, “provision priority”, and “hobby-linked provision mode”. Example inputs to the AI model include “hobby one-hot vector (e.g., cooking 1, cleaning 1, DIY 0)”, “frequency of household-related posts on social media”, and “interest field label”. The AI model generates outputs such as “priority procedures to be provided (e.g., cooking, cleaning)”, “level of detail of provision (e.g., detailed for cooking, summary for cleaning)”, and “provision timing (e.g., immediately after hobby-related posts)”. Example outputs include “focus on providing cooking procedures this week”, “provide cleaning procedures in summary version”, and “provide DIY procedures only once a month”. Based on these outputs, the provision scheduler or filtering module automatically adjusts provision targets, frequency, and level of detail. Internally, the AI model combines supervised learning (e.g., loss function minimization using past hobby/interest labeled data), clustering (e.g., user classification by hobby pattern), and reinforcement learning (e.g., provision strategy optimization to maximize provision efficiency), thereby realizing hobby/interest-linked provision control in a high-dimensional space, which is different from conventional manual settings or simple rule-based processing. As a result, the provision unit enables flexible procedure provision according to the user's hobbies and interests, and demonstrates improvements to computer technology itself, such as increased provision efficiency, improved user satisfaction, and enhanced system scalability. Application fields include hobby-linked procedure provision for household support in general homes, individual needs identification in nursing care settings, task content customization in business settings, and provision of procedures based on students' interest fields in educational settings.

The following is a brief explanation of the processing flow of Example of the Embodiment. Specifically, in this system, as Step 1, the collection unit collects household task data (e.g., task type such as cleaning, laundry, cooking, task procedures, required time, tools used, task result score, user attributes, multidimensional metadata such as emotion, health, lifestyle rhythm, family composition, hobbies, location information, social media activity, etc.) from wearable devices, smartphones, stationary sensor units, etc. as time-series tensors or categorical vectors, and the preprocessing unit performs noise removal, normalization, and feature extraction (e.g., heart rate variability analysis, activity pattern estimation, lifestyle rhythm classification, family composition estimation, hobby estimation, location estimation, household interest estimation, etc.). As Step 2, the analysis unit analyzes the multidimensional data collected by the collection unit using convolutional neural networks (CNN), recurrent neural networks (RNN), graph neural networks (GNN), Transformer-based multimodal analysis models, etc., and learns the time required for household tasks, efficiency improvement points, task dependency relationships, and the influence of user emotion, health, lifestyle rhythm, family composition, hobbies, location information, etc. The analysis unit combines supervised learning, reinforcement learning, clustering, etc. to perform efficiency improvement point extraction, task priority estimation, analysis level of detail control, algorithm selection by category, emotion/health/lifestyle rhythm-linked analysis, relevance/time-series-linked analysis, etc. As Step 3, the generation unit automatically generates optimized household task procedures for each user (e.g., procedure level of detail, simplification parameters, parallel tasks, process order, tool selection, etc.) using dynamic programming or reinforcement learning-based procedure optimization algorithms based on the results learned by the analysis unit. The generation unit considers metadata such as emotion, health, lifestyle rhythm, family composition, hobbies, location information, etc. to realize procedure customization and personalization. As Step 4, the provision unit provides the procedures generated by the generation unit to the user by the optimal means, timing, and level of detail according to the user's usage environment, device type, usage history, emotion, health, lifestyle rhythm, family composition, hobbies, location information, etc., such as app notification, voice assistant, email, printed guide, etc. The provision unit automatically adjusts the provision method using the output of the AI model in the provision scheduler or notification control module, supporting reduction of user burden and efficiency of household tasks. Through these processing flows, the system realizes multivariate data analysis, procedure optimization, and personalized provision in a high-dimensional space, which is different from conventional manual work or simple rule-based processing, and demonstrates improvements to computer technology itself, such as improved analysis accuracy, increased proposal speed, improved user satisfaction, and enhanced system scalability. Application fields include household support in general homes, task efficiency improvement in nursing care settings, process optimization in business settings, learning support in educational settings, optimization of care procedures in medical settings, support for traditional culture succession in local governments, and design of experience programs in the tourism industry.

Step 1: The collection unit collects household task data. Household task data includes task data such as cleaning, laundry, and cooking. The collection unit collects detailed data on the type, time, and procedures of household tasks using wearable devices. For example, the collection unit records and collects data such as tools and procedures used for cleaning, procedures and time for laundry, and procedures and time for cooking. Step 2: The analysis unit analyzes the data collected by the collection unit and learns the time required for household tasks. The analysis unit identifies efficiency improvement points for household tasks based on the collected data. For example, the analysis unit analyzes the time and procedures required for cleaning and identifies which parts require the most time. The analysis unit also analyzes the time and procedures required for laundry and cooking to identify efficiency improvement points. Step 3: The generation unit generates procedures for time reduction based on the results learned by the analysis unit. The generation unit proposes procedures for improving the efficiency of household tasks. For example, the generation unit reviews cleaning procedures and proposes efficient cleaning methods. The generation unit also reviews laundry and cooking procedures and proposes efficient methods. Step 4: The provision unit provides the procedures generated by the generation unit to the user. The provision unit notifies the procedures via an application. For example, the provision unit notifies efficient cleaning methods via a smartphone application. The provision unit can also provide procedures via printed guides or email. Specifically, in Step 1, the system collects multidimensional data (e.g., task type, task procedures, required time, tools used, task result score, user attributes, multidimensional metadata such as emotion, health, lifestyle rhythm, family composition, hobbies, location information, social media activity, etc.) from wearable devices, smartphones, stationary sensor units, etc. as time-series tensors or categorical vectors, and the preprocessing unit performs noise removal, normalization, and feature extraction (e.g., heart rate variability analysis, activity pattern estimation, lifestyle rhythm classification, family composition estimation, hobby estimation, location estimation, household interest estimation, etc.). In Step 2, the analysis unit analyzes the multidimensional data collected by the collection unit using convolutional neural networks (CNN), recurrent neural networks (RNN), graph neural networks (GNN), Transformer-based multimodal analysis models, etc., and learns the time required for household tasks, efficiency improvement points, task dependency relationships, and the influence of user emotion, health, lifestyle rhythm, family composition, hobbies, location information, etc. The analysis unit combines supervised learning, reinforcement learning, clustering, etc. to perform efficiency improvement point extraction, task priority estimation, analysis level of detail control, algorithm selection by category, emotion/health/lifestyle rhythm-linked analysis, relevance/time-series-linked analysis, etc. In Step 3, the generation unit automatically generates optimized household task procedures for each user (e.g., procedure level of detail, simplification parameters, parallel tasks, process order, tool selection, etc.) using dynamic programming or reinforcement learning-based procedure optimization algorithms based on the results learned by the analysis unit. The generation unit considers metadata such as emotion, health, lifestyle rhythm, family composition, hobbies, location information, etc. to realize procedure customization and personalization. In Step 4, the provision unit provides the procedures generated by the generation unit to the user by the optimal means, timing, and level of detail according to the user's usage environment, device type, usage history, emotion, health, lifestyle rhythm, family composition, hobbies, location information, etc., such as app notification, voice assistant, email, printed guide, etc. The provision unit automatically adjusts the provision method using the output of the AI model in the provision scheduler or notification control module, supporting reduction of user burden and efficiency of household tasks. Through these processing flows, the system realizes multivariate data analysis, procedure optimization, and personalized provision in a high-dimensional space, which is different from conventional manual work or simple rule-based processing, and demonstrates improvements to computer technology itself, such as improved analysis accuracy, increased proposal speed, improved user satisfaction, and enhanced system scalability. Application fields include household support in general homes, task efficiency improvement in nursing care settings, process optimization in business settings, learning support in educational settings, optimization of care procedures in medical settings, support for traditional culture succession in local governments, and design of experience programs in the tourism industry.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search<URL: https: //openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, generation unit, and provision unit is implemented, for example, by at least one of a smart device 14 and a data processing apparatus 12. For example, the collection unit collects data on household tasks using a camera 42 or a microphone 38B of the smart device 14, and records the data by a control unit 46A. The analysis unit is implemented, for example, by a specific processing unit 290 of the data processing apparatus 12, and analyzes the collected data to learn the time required for household tasks. The generation unit is implemented, for example, by the specific processing unit 290 of the data processing apparatus 12, and generates procedures for time reduction based on the analysis results. The provision unit is implemented, for example, by the control unit 46A of the smart device 14, and notifies the user of the generated procedures. The correspondence between each unit and the device or control unit is not limited to the examples described above, and various modifications are possible.

### Second Embodiment

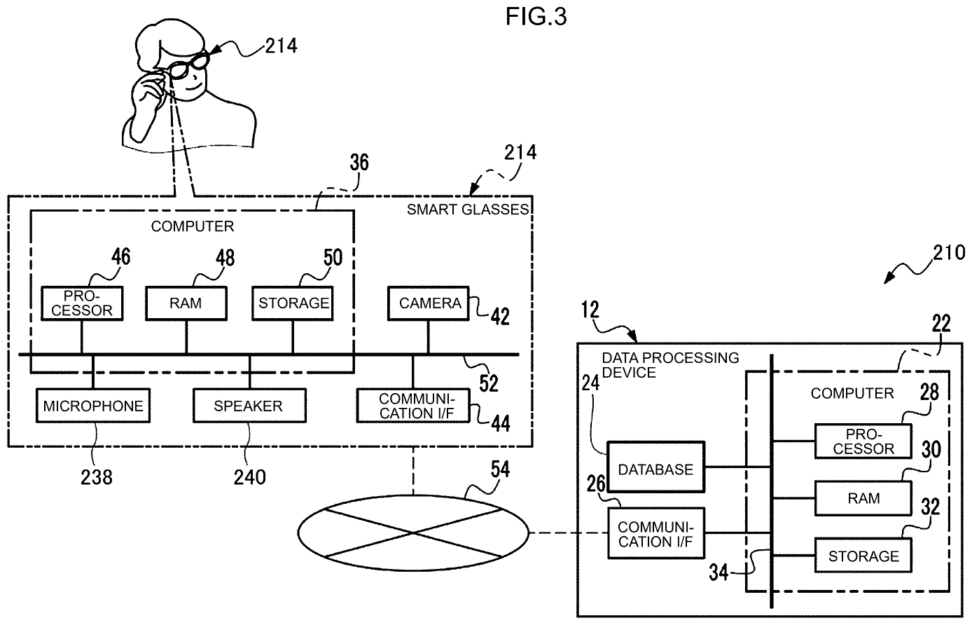

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

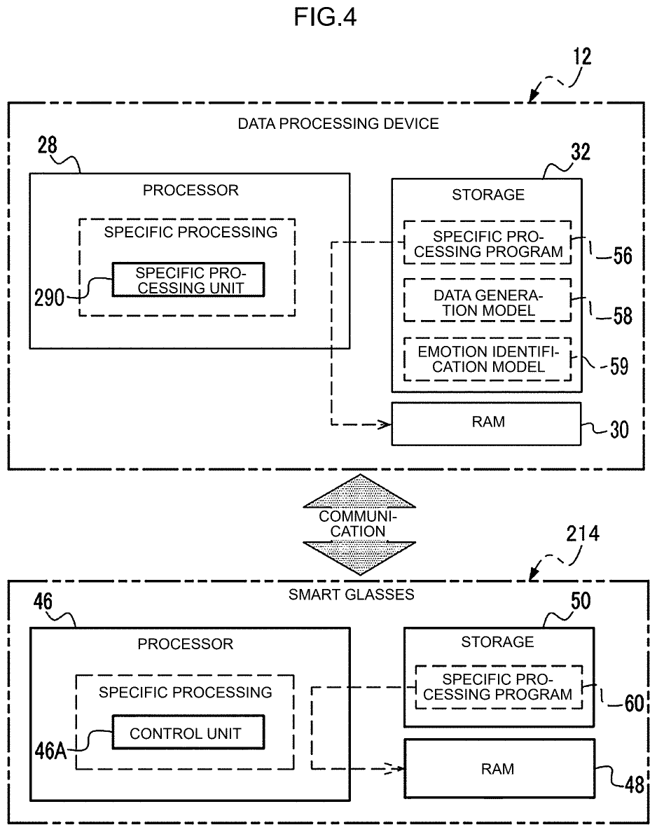

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, generation unit, and provision unit is implemented, for example, by at least one of smart glasses 214 and a data processing apparatus 12. For example, the collection unit collects data on household tasks using a camera 42 or a microphone 238 of the smart glasses 214, and records the data by a control unit 46A. The analysis unit is implemented, for example, by a specific processing unit 290 of the data processing apparatus 12, and analyzes the collected data to learn the time required for household tasks. The generation unit is implemented, for example, by the specific processing unit 290 of the data processing apparatus 12, and generates procedures for time reduction based on the analysis results. The provision unit is implemented, for example, by the control unit 46A of the smart glasses 214, and notifies the user of the generated procedures. The correspondence between each unit and the device or control unit is not limited to the examples described above, and various modifications are possible.

### Third Embodiment

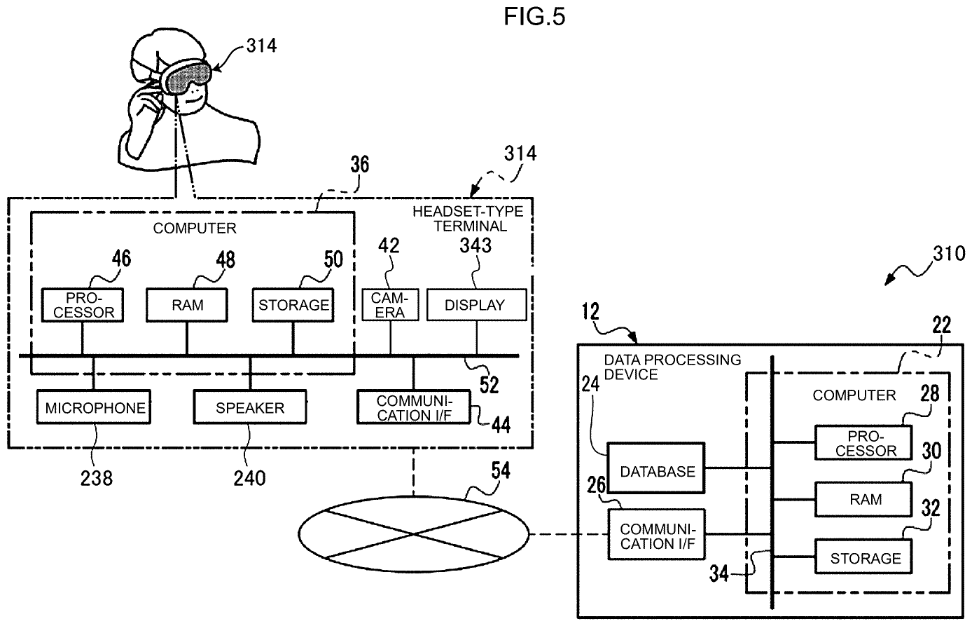

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

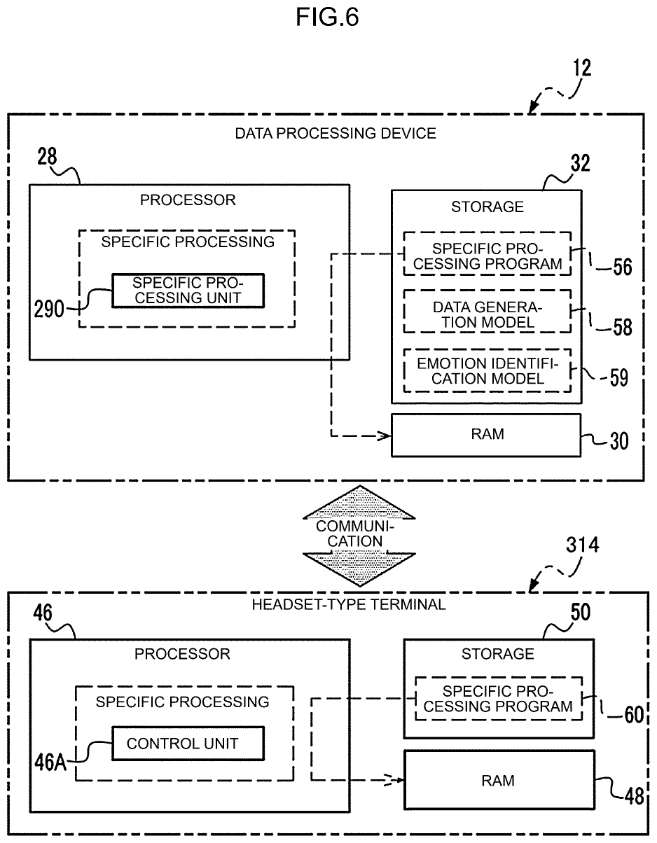

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, generation unit, and provision unit is implemented, for example, by at least one of a headset-type terminal 314 and a data processing apparatus 12. For example, the collection unit collects data on household tasks using a camera 42 or a microphone 238 of the headset-type terminal 314, and records the data by a control unit 46A. The analysis unit is implemented, for example, by a specific processing unit 290 of the data processing apparatus 12, and analyzes the collected data to learn the time required for household tasks. The generation unit is implemented, for example, by the specific processing unit 290 of the data processing apparatus 12, and generates procedures for time reduction based on the analysis results. The provision unit is implemented, for example, by the control unit 46A of the headset-type terminal 314, and notifies the user of the generated procedures. The correspondence between each unit and the device or control unit is not limited to the examples described above, and various modifications are possible.

### Fourth Embodiment

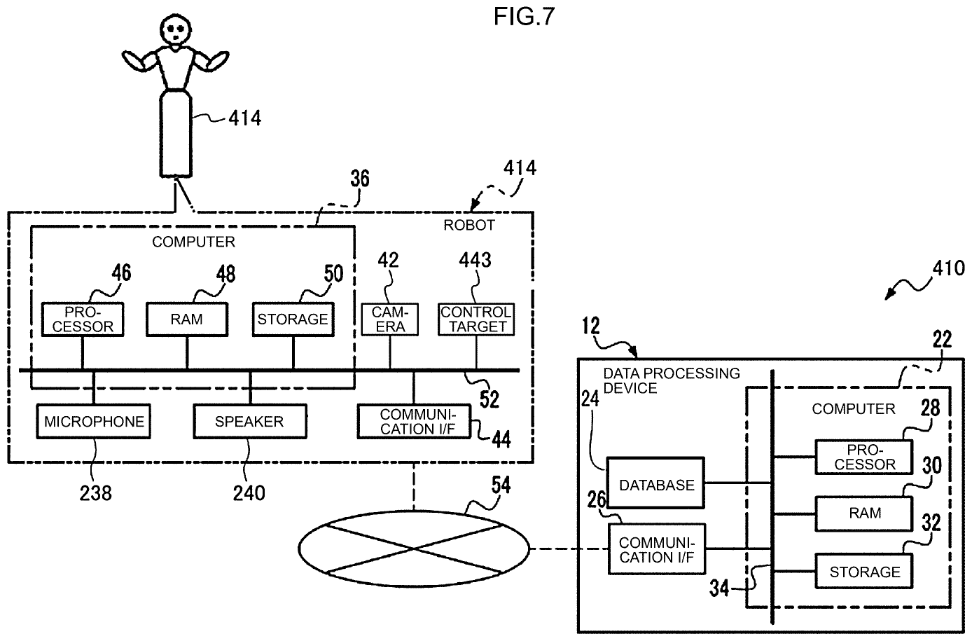

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

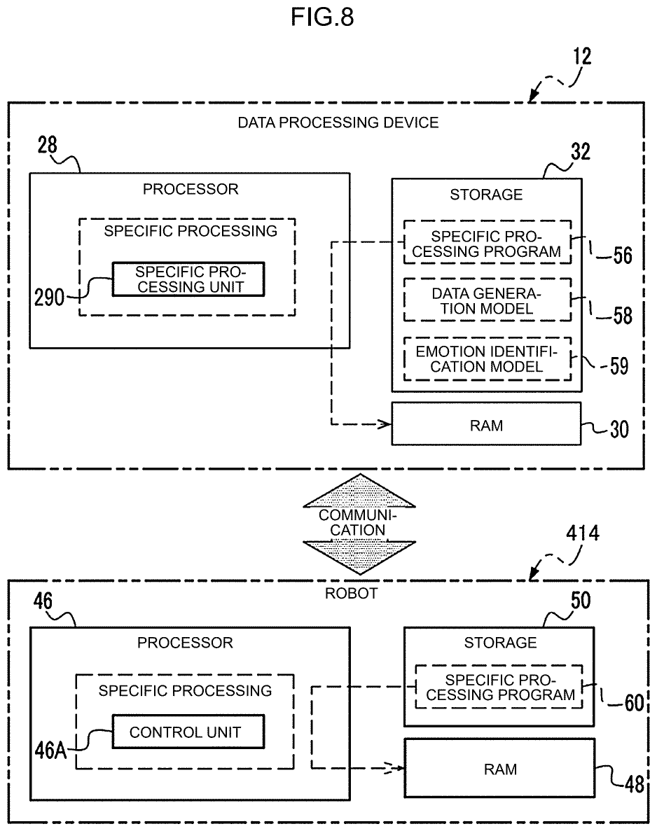

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, generation unit, and provision unit is implemented, for example, by at least one of a robot 414 and a data processing apparatus 12. For example, the collection unit collects data on household tasks using a camera 42 or a microphone 238 of the robot 414, and records the data by a control unit 46A. The analysis unit is implemented, for example, by a specific processing unit 290 of the data processing apparatus 12, and analyzes the collected data to learn the time required for household tasks. The generation unit is implemented, for example, by the specific processing unit 290 of the data processing apparatus 12, and generates procedures for time reduction based on the analysis results. The provision unit is implemented, for example, by the control unit 46A of the robot 414, and notifies the user of the generated procedures. The correspondence between each unit and the device or control unit is not limited to the examples described above, and various modifications are possible.

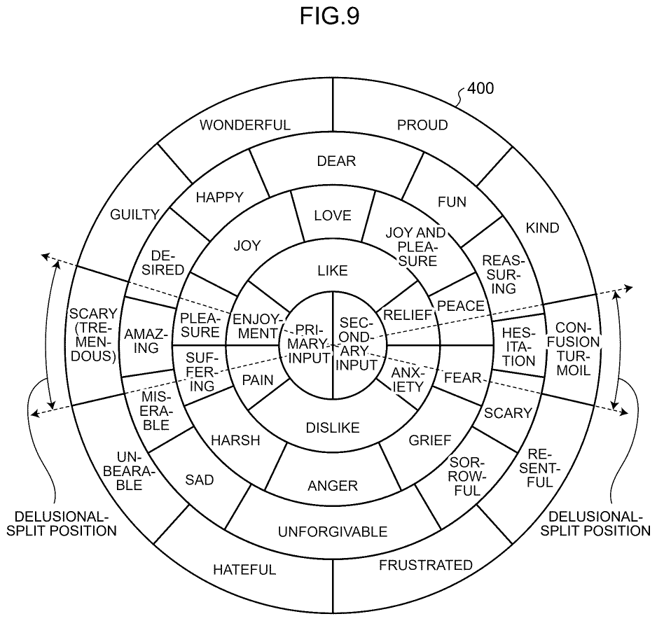

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci. nii.ac. jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

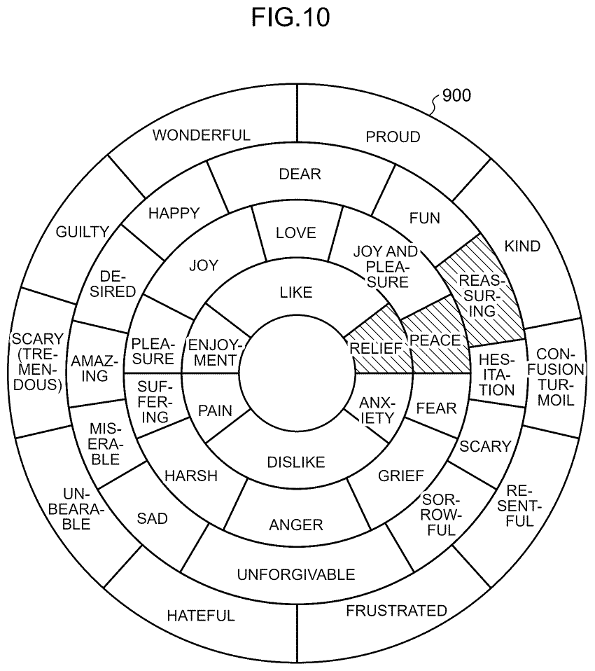

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect data on household tasks; an analysis unit configured to analyze the data collected by the collection unit and learn the time required for household tasks; a generation unit configured to generate procedures for time reduction based on the results learned by the analysis unit; and a provision unit configured to provide the procedures generated by the generation unit to a user.

(Supplementary Note 2) The system according to Supplementary Note 1, wherein the collection unit is configured to collect data on the type or time of household tasks, and procedures.

(Supplementary Note 3) The system according to Supplementary Note 1, wherein the analysis unit is configured to learn the time required for household tasks based on the collected data.

(Supplementary Note 4) The system according to Supplementary Note 1, wherein the generation unit is configured to generate procedures for time reduction based on the learned results.

(Supplementary Note 5) The system according to Supplementary Note 1, wherein the provision unit is configured to provide the generated procedures to the user.

(Supplementary Note 6) The system according to Supplementary Note 1, wherein the provision unit is configured to input methods from household workers nationwide and provide procedures that reproduce traditional methods continued in local areas.

(Supplementary Note 7) The system according to Supplementary Note 1, wherein the collection unit is configured to estimate the user's emotions and adjust the timing of collecting household task data based on the estimated emotions of the user.

(Supplementary Note 8) The system according to Supplementary Note 1, wherein the collection unit is configured to analyze the user's past household task history at the time of collecting household task data and select a collection method.

(Supplementary Note 9) The system according to Supplementary Note 1, wherein the collection unit is configured to perform filtering based on the user's current living situation or areas of interest at the time of collecting household task data.

(Supplementary Note 10) The system according to Supplementary Note 1, wherein the collection unit is configured to estimate the user's emotions and determine the priority of household task data to be collected based on the estimated emotions of the user.

(Supplementary Note 11) The system according to Supplementary Note 1, wherein the collection unit is configured to preferentially collect highly relevant data by considering the user's geographic location information at the time of collecting household task data.

(Supplementary Note 12) The system according to Supplementary Note 1, wherein the collection unit is configured to analyze the user's social media activity at the time of collecting household task data and collect relevant data.

(Supplementary Note 13) The system according to Supplementary Note 1, wherein the analysis unit is configured to estimate the user's emotions and adjust the analysis method for household tasks based on the estimated emotions of the user.

(Supplementary Note 14) The system according to Supplementary Note 1, wherein the analysis unit is configured to adjust the level of detail of analysis based on the importance of household tasks during analysis.

(Supplementary Note 15) The system according to Supplementary Note 1, wherein the analysis unit is configured to apply different analysis algorithms according to the category of household tasks during analysis.

(Supplementary Note 16) The system according to Supplementary Note 1, wherein the analysis unit is configured to estimate the user's emotions and determine the priority of analysis based on the estimated emotions of the user.

(Supplementary Note 17) The system according to Supplementary Note 1, wherein the analysis unit is configured to determine the priority of analysis based on the implementation timing of household tasks during analysis.

(Supplementary Note 18) The system according to Supplementary Note 1, wherein the analysis unit is configured to adjust the order of analysis based on the relevance of household tasks during analysis.

(Supplementary Note 19) The system according to Supplementary Note 1, wherein the generation unit is configured to adjust the order of procedures to be generated based on the relevance of household tasks during generation.

(Supplementary Note 20) The system according to Supplementary Note 1, wherein the provision unit is configured to estimate the user's emotions and adjust the method of providing procedures based on the estimated emotions of the user.

(Supplementary Note 21) The system according to Supplementary Note 1, wherein the provision unit is configured to select a provision method by referring to the user's past procedure usage history at the time of provision.

(Supplementary Note 22) The system according to Supplementary Note 1, wherein the provision unit is configured to customize the means of providing procedures based on the user's current living situation at the time of provision.

(Supplementary Note 23) The system according to Supplementary Note 1, wherein the provision unit is configured to estimate the user's emotions and determine the priority of providing procedures based on the estimated emotions of the user.

(Supplementary Note 24) The system according to Supplementary Note 1, wherein the provision unit is configured to provide procedures by considering the user's geographic location information at the time of provision.

(Supplementary Note 25) The system according to Supplementary Note 1, wherein the provision unit is configured to analyze the user's social media activity at the time of provision and propose means of providing procedures.

What is claimed is:

1. A system comprising:
circuitry configured to:
receive, via a packet-switched network from a client terminal, time-series sensor data sampled from a plurality of sensors associated with a user;
preprocess the time-series sensor data by performing noise removal, normalization, and feature extraction to generate structured data comprising a plurality of operational parameters;
input the structured data into a neural network model comprising at least one of a convolutional neural network, a recurrent neural network, or a Transformer-based model to compute an efficiency score and identify at least one optimization parameter for the operational parameters;
generate inference data by inputting the optimization parameter and the structured data into a data generation model to produce optimized procedural data; and
transmit the optimized procedural data to the client terminal via the packet-switched network.

2. The system according to claim 1, wherein the time-series sensor data comprises at least one of acceleration sensor data sampled along three axes, spectrogram data derived from audio recordings, image data comprising RGB value arrays, or touch operation log data comprising event sequences with timestamps.

3. The system according to claim 1, wherein the structured data further comprises a task type identifier, a start time, an end time, a tool identifier, and a procedure number for each of a plurality of operational segments identified from the time-series sensor data.

4. The system according to claim 1, wherein the neural network model combines a convolutional neural network for image and time-series feature extraction, a recurrent neural network for learning dependencies between operational steps, and a Transformer-based model for analyzing long-term dependencies among the operational parameters.

5. The system according to claim 1, wherein the circuitry is further configured to estimate an emotion of the user by inputting biometric sensor data received from the client terminal into an emotion identification model, and adjust a timing of receiving the time-series sensor data based on the estimated emotion.

6. The system according to claim 5, wherein the biometric sensor data comprises at least one of heart rate variability data, skin conductance response data, facial image data, voice tone feature data, or touch operation pressure data.

7. The system according to claim 1, wherein the circuitry is further configured to analyze past operational data stored in a database associated with the user, and select a data collection method based on the past operational data by analyzing content trends and usage patterns.

8. The system according to claim 1, wherein the circuitry is further configured to receive attribute information of the user from the client terminal, the attribute information comprising at least one of a living situation indicator or an area-of-interest indicator, and filter the time-series sensor data based on the attribute information prior to preprocessing.

9. The system according to claim 1, wherein the circuitry is further configured to estimate an emotion of the user based on biometric sensor data received from the client terminal, and determine a priority of the time-series sensor data to be received based on the estimated emotion, such that when the estimated emotion indicates stress, the circuitry defers reception of low-importance data, and when the estimated emotion indicates relaxation, the circuitry prioritizes reception of high-importance data.

10. The system according to claim 1, wherein the circuitry is further configured to receive geographic location information of the user from the client terminal and preferentially receive time-series sensor data associated with a geographic region corresponding to the geographic location information.

11. The system according to claim 1, wherein the circuitry is further configured to receive social media activity data of the user from the client terminal, analyze the social media activity data using a natural language processing model to extract interest topics, and adjust a priority of the time-series sensor data to be received based on the extracted interest topics.

12. The system according to claim 1, wherein the circuitry is further configured to estimate an emotion of the user based on biometric sensor data received from the client terminal, and adjust an analysis method applied by the neural network model based on the estimated emotion, such that when the estimated emotion indicates stress, the circuitry applies a simplified analysis, and when the estimated emotion indicates relaxation, the circuitry applies a detailed analysis.

13. The system according to claim 1, wherein the circuitry is further configured to apply different analysis algorithms according to a category of the operational parameters.

14. The system according to claim 1, wherein the circuitry is further configured to determine a priority of the analysis based on an implementation timing associated with the operational parameters, such that the circuitry preferentially analyzes operational parameters associated with imminent implementation.

15. The system according to claim 1, wherein the circuitry is further configured to analyze dependencies among the operational parameters using at least one of a graph neural network or a Transformer-based dependency analysis model to determine a relevance score, and adjust an order of the analysis based on the relevance score.

16. The system according to claim 1, wherein the circuitry is further configured to estimate an emotion of the user based on biometric sensor data received from the client terminal, and adjust a level of detail of the optimized procedural data based on the estimated emotion, such that when the estimated emotion indicates stress, the circuitry generates simplified procedural data, and when the estimated emotion indicates relaxation, the circuitry generates detailed procedural data.

17. The system according to claim 1, wherein the circuitry is further configured to estimate an emotion of the user based on biometric sensor data received from the client terminal, and adjust a method of transmitting the optimized procedural data based on the estimated emotion, such that when the estimated emotion indicates stress, the circuitry transmits a summary version, and when the estimated emotion indicates relaxation, the circuitry transmits a detailed version.

18. A system comprising:
a communication interface comprising a communication processor and an antenna, the communication interface configured to communicate via a packet-switched network conforming to at least one of a 5G, Wi-Fi, or Bluetooth communication standard;
a processor comprising at least one of a central processing unit, a graphics processing unit, or a tensor processing unit;
a random-access memory connected to the processor via a bus;
a memory storing a data generation model obtained by performing deep learning on a neural network and an emotion identification model; and
a database connected to the bus;
circuitry configured to:
receive, via the communication interface from a client terminal, time-series sensor data sampled from a plurality of sensors associated with a user, the plurality of sensors comprising at least one of an accelerometer, a microphone, a camera comprising a CMOS or CCD image sensor, or a touch panel;
preprocess the time-series sensor data by performing noise removal using a filter, normalization using Z-score normalization, and feature extraction comprising detection of operation start and end points and segmentation of operational intervals, to generate structured data comprising a task type identifier, a start time, an end time, a tool identifier, and a procedure number;
input the structured data into a neural network model comprising at least one of a convolutional neural network, a recurrent neural network, or a Transformer-based model to compute an efficiency score and identify at least one optimization parameter;
estimate an emotion of the user by inputting biometric sensor data received from the client terminal into the emotion identification model stored in the memory to generate an emotion label and an emotion score;
generate inference data by inputting the optimization parameter, the structured data, and the emotion score into the data generation model stored in the memory to produce optimized procedural data; store the optimized procedural data in the database; and
transmit the optimized procedural data to the client terminal via the communication interface.

19. The system according to claim 18, wherein the circuitry is further configured to select a transmission method for the optimized procedural data from a plurality of transmission methods comprising an application notification, an electronic mail, and a voice output, based on a usage history of the user stored in the database and the emotion score.

20. A method performed by circuitry of a system, the method comprising:
receiving, via a packet-switched network from a client terminal, time-series sensor data sampled from a plurality of sensors associated with a user;
preprocessing the time-series sensor data by performing noise removal, normalization, and feature extraction to generate structured data comprising a plurality of operational parameters;
inputting the structured data into a neural network model comprising at least one of a convolutional neural network, a recurrent neural network, or a Transformer-based model to compute an efficiency score and identify at least one optimization parameter for the operational parameters;
generating inference data by inputting the optimization parameter and the structured data into a data generation model to produce optimized procedural data; and
transmitting the optimized procedural data to the client terminal via the packet-switched network.
